(19) United States
(12) Patent Application Publication
(10) Pub. No.: US 2019/0084016 A1
(43) Pub. Date: Mar. 21, 2019

(54) Pipe Assembly, Cooling System with Pipe Assembly and Method of Cooling a Fluid

(71) Applicant: EMPIG AS, Trondheim (NO)

(72) Inventors: Lars Standal STROMMEGJERDE, Ranheim (NO); Fredrik LUND, Trondheim (NO)

(21) Appl. No.: 16/083,120

(22) PCT Filed: Mar. 7, 2017
(86) PCT No.: PCT/EP2017/055359

§ 371 Date: Sep. 7, 2018

(30) Foreign Application Priority Data
Mar. 7, 2016 (GB) 1603874.7

(51) Int. Cl. B08B 7/00; B08B 9/027; B08B 17/00; E21B 43/20; F16L 53/34; F16L 53/37; F28G 13/00

(52) U.S. Cl. CPC B08B 7/0071; B08B 9/027; B08B 17/00; F28G 13/005; F16L 53/34; F16L 53/37; E21B 43/20

(57) ABSTRACT

Disclosed herein is a pipe assembly comprising: a pipe with an electrically conductive wall with a thermally conductive outer coating; a first electrical connector that is arranged in electrical contact with the wall of the pipe; and a second electrical connector that is arranged in electrical contact with the wall of the pipe; wherein the first and second electrical connectors are arranged to support the flow of an electrical current through the wall of the pipe to thereby heat the wall of the pipe; and in use, the pipe is arranged to allow cooling of the outer surface of the wall of the pipe by the surrounding environment of the pipe when the outer surface of the wall of the pipe is hotter than its surrounding environment. Advantageously, embodiments provide an effective, efficient and less expensive technique for heating the pipe in order to remove deposits for the inner walls of the pipes. Applications include the subsea application of cooling oil well products for cold flow.

### FIELD

The present invention relates to a system for cooling a fluid. A particularly advantageous application of a system according to embodiments is the use of the system for the subsea cooling of an oil well product. The system comprises a new and advantageous periodical heating mechanism for heating the walls of the system's pipes in order to remove deposit build up from the oil well product on the inner walls of the system's pipes. An efficient and effective cooling system is provided that has a mechanism for preventing deposits blocking, or reducing flow, in the system's pipes.

### BACKGROUND

In the subsea extraction of oil well products, pipes are used to transport the oil well products from the seafloor to the surface and also along the seafloor in subsea pipe networks that may comprise lengths of pipe up to about 100-150 km. The pipes that are used to transport the oil well products, such as petroleum/oil, gas or other fluids, can become blocked or lose efficiency due to the formation of deposits on the inside of their walls. The deposits can be any of foreign materials, detritus, or natural waste products such as paraffin, calcium, wax, hydrates, scaling, naftenat and asphaltenes. The temperature of an oil well product on exit from a sea floor varies, but is normally in the range of 60° C. to 80° C. It is therefore at a much higher temperature than the surrounding water at the sea floor. In the North Sea, the temperature of water at the sea floor is typically at about 4° C. to 5° C. but the temperature of the water may be higher or lower in other locations. The formation of deposits occurs when the temperature of the oil well product falls below a deposit forming temperature. The deposit forming temperature depends on the pressure and constituents of the oil well product but wax deposits will typically form when the temperature falls below about 40° C. to 50° C. and hydrate deposits typically form when the temperature of the oil well product falls below 25° C.

A number of different techniques exist for either removing such deposits or maintaining conditions that prevent such deposits from forming.

The techniques for removing a deposit from the inner wall of a pipe include the use of a pig, which is a scraper plug, that is pushed by fluid pressure (pushed from topside or well) along the inside of the pipe to scrape off the deposits. However, the inherent requirement of moving parts and complicated piping reduces the reliability of pig based systems. Another technique for removing and reducing deposits is the injection of chemicals into the fluid flow. However, this is expensive due to the cost of the additional piping and valves, the regeneration of chemicals and the chemicals themselves. The injection of chemicals can also cause environmental problems.

There are also techniques for preventing deposits from forming by maintaining the oil well product above the deposit forming temperature. One such technique is Direct Electric Heating (DEH). This is described in the paper ‘Direct Electrical Heating of Subsea Pipelines—Technology Development and Operating Experience’, Nysveen et al., IEEE Transactions on Industry Applications, (Volume: 43, Issue: 1), pages 118 to 129, January-February 2007. DEH technology uses heating to keep the oil well products in a pipe warm so that the oil well products are maintained above the deposit forming temperature. The heating is provided by passing an electric current through the wall of a pipe. In order to help maintain the oil well product above the deposit forming temperature, it is essential for the pipe to be coated with thermal insulation. An advantage of DEH is that it is more efficient and cheaper than other forms of heating a pipe to maintain the temperature of an oil well product above the deposit forming temperature.

Another method for removing deposits is described in U.S. Pat. No. 8,623,147B2, referred to herein as US'147. This patent discloses a technique for removing deposits by first allowing the oil well products in a pipe to cool below the deposit forming temperature and then pulse heating the oil well product so that the deposits are removed as solid parts by the flow of the oil well product.

Heating techniques disclosed in US'147 include the use of external heating with an electrical heater and flushing with a hot fluid from a heat exchanger.

There is a need to improve known techniques for removing deposit formations on the inside of pipes and, more generally, the cooling of hot fluids when deposits may form.

### SUMMARY

According to a first aspect of the invention, there is provided a pipe assembly comprising: a pipe with an electrically conductive wall with a thermally conductive, and electrically insulating, outer coating; a first electrical connector that is arranged in electrical contact with the wall of the pipe; and a second electrical connector that is arranged in electrical contact with the wall of the pipe; wherein the first and second electrical connectors are arranged to support the flow of an electrical current through the wall of the pipe to thereby heat the wall of the pipe; and in use, the pipe is arranged to allow cooling of the outer surface of the wall of the pipe by the surrounding environment of the pipe when the outer surface of the wall of the pipe is hotter than its surrounding environment.

Preferably, an outer surface of the coating is in direct contact with the surrounding environment of the pipe and an inner surface of the coating is in direct contact with the wall of the pipe.

Preferably, the coating is an electrical insulator.

Preferably, the coating is not designed to provide thermal insulation.

Preferably, the coating is a ceramic.

Preferably, the coating is one of boron nitride, aluminium nitride, aluminium oxide, chromium nitride, zirconium nitride, boron nitride, dichromium nitride, titanium aluminium nitride, chromium aluminium nitride, and titanium nitride, alkaline earth metal nitrides and alkali metal nitrides, and aluminium thermal spray.

Preferably, no thermal insulation is provided along the length of the pipe between the first and second electrical connectors.

Preferably, the pipe assembly further comprises an electrical cable that is arranged in electrical contact with the second electrical connector such that the cable is in a series electrical connection with the pipe.

Preferably, the cable is arranged along the length of the pipe.

Preferably, the cable is arranged to substantially lie along the outer surface of the pipe.

Preferably, the longitudinal axes of the cable and pipe are substantially parallel with each other.

Preferably, the pipe assembly further comprises one or more sacrificial anodes.

Preferably, one or more sacrificial anodes are arranged on the exterior surface of the pipe and in direct electrical contact with the wall of the pipe.

Preferably, one or more sacrificial anodes are arranged in an anode bank; and the anode bank is electrically connected to the wall of the pipe by a cable.

Preferably, at least one sacrificial anode is provided in proximity to the first and/or second electrical connectors.

Preferably, either the pipe is linear or the pipe comprises a plurality of bends and/or has a wavelike shape.

Preferably, the pipe assembly is for use in subsea applications, such as the transportation of oil well products.

Preferably, the pipe has an inner diameter in the range 5.08 cm to 30.48 cm.

Preferably, the pipe has a length in the range 300 m to 6000 m

Preferably the pipe assembly further comprises a cooling element for cooling fluids flowing through the pipe, wherein at least part of the cooling element is located inside the pipe.

Preferably: a first end of the cooling element is located inside the pipe; and a second end of the cooling element is located outside of the pipe; wherein the cooling element is provided through a hole in the wall of the pipe; and the second end of the cooling element is a heat sink.

According to a second aspect of the invention, there is provided a system for cooling a fluid, the system comprising: a pipe assembly according to the first aspect; and an electrical power supply in electrical connection with the first and second connectors of the pipe assembly; wherein, in use, the electrical power supply causes electrical current to flow through the wall of the pipe between the first and second electrical connectors in dependence on an on/off supply of the electrical current.

Preferably, the electrical power supply is configured to cause a direct current to flow through the pipe.

Preferably, the electrical power supply is configured to cause an alternating current to flow through the pipe.

Preferably, the electrical power supply is configured to cause alternating current to flow through both the pipe and the cable.

Preferably, the system comprises a plurality of pipe assemblies according to the first aspect.

Preferably, the system further comprises: an input port for receiving an input fluid flow to the system; and an output port for providing an output fluid flow of fluid that has flowed through one or more pipe assemblies comprised by the system.

Preferably, the system further comprises: a return pipe for providing a return flow path between the output port of the system and the input port of the system such that, in use, at least some of the fluid that has flowed through one or more pipe assemblies comprised by the system flows through the return pipe and through the one or more pipe assemblies again.

Preferably, the system further comprises one or more pumps and valves for providing a flow of fluid through the return pipe.

Preferably, the electrical power supply is configured to heat the return pipe in dependence on an on/off supply of electrical current.

Preferably, the plurality of pipe assemblies are stacked together.

Preferably, the system further comprises: a splitting system arranged to split the input fluid flow into a plurality of fluid flows and supply each of the plurality of fluid flows to one of the pipe assemblies; and a combining system arranged to combine each of the fluid flows output from the plurality of pipe assemblies and to provide the combined fluid flow to the output port.

Preferably the system further comprises a valve system for controlling the fluid flow in each of the plurality of pipe assemblies.

Preferably, the plurality of pipe assemblies are arranged substantially co-linearly with each other.

Preferably, the system further comprises an electrical switching system for controlling the flow of electrical current through the pipes of each of the plurality of pipe assemblies.

Preferably, for each of one or more of the pipe assemblies, the electrical switching system comprises one or more switches for controlling the flow of an electrical current through different sections of the pipe assembly.

Preferably, the system further comprises a control system for controlling the heating of the one or more pipe assemblies by the electrical power supply.

Preferably, the control system is configured to periodically heat one or more pipe assemblies and/or sections of each of the one or more pipe assemblies.

Preferably, the system is for use in subsea applications.

Preferably, the system is configured to receive an oil well product, that is at a higher temperature than the ambient temperature of the system, and to cool the oil well product such that the oil well product output from the system is below a deposit forming temperature of the oil well product and, preferably, substantially at the ambient temperature of the system.

Preferably, each pipe of the one or more pipe assemblies is arranged such that, when in use in a subsea environment, the pipe is cooled by the seawater.

Preferably, the electrical power supply is configured to heat each pipe segment of the system once or more during a 24 hour period; and preferably, each of a plurality of segments are sequentially heated.

Preferably, the electrical power supply is configured to heat the wall of the pipe to at least 50° C.

Preferably, in use, the power supplied by the electrical power supply is about 1.5 kW for each 1m length of the wall of the segment of the pipe that is being heated; the pipe has a diameter of 76.2 mm, and the power is supplied for about 120 seconds.

Preferably, in use, the power supplied by the electrical power supply is about 35 kW for each 1m length of the wall of the segment of the pipe that is being heated; the pipe has a diameter of 254 mm, and the power is supplied for about 660 seconds.

Preferably, in use, the power supplied by the electrical power supply is about 35.7 kW for each 1m length of the wall of the segment of the pipe that is being heated; the pipe has a diameter of 304.8 mm, and the power is supplied for about 660 seconds.

Preferably the system further comprises a cleaning system for cleaning the outside of the pipes of the system.

Preferably the system further comprises a water and/or gas separator configured to remove some of the water and/or gas of a fluid prior to the fluid being received at said fluid input of the system.

According to a third aspect of the invention, there is provided a method of cooling a fluid, the method comprising: receiving a fluid at a fluid input of a system according to the second aspect; and outputting the fluid from the system.

Preferably, the method comprises: heating the pipes of one or more of the pipe assemblies in the system so as to remove a deposit from the interior of the wall of one or more pipes of the system.

Preferably, the method is for cooling a fluid in subsea applications.

Preferably, the fluid is an oil well product.

Preferably, said heating the pipes of one or more of the pipe assemblies in the system heats the inner surface of a pipe to a temperature above the temperature at which deposits form.

Preferably, said heating the pipes of one or more of the pipe assemblies in the system heats the inner surface of a pipe to a maximum temperature that is below the temperature at which wax in the deposits melts.

Preferably, each pipe segment of the system is configured to be heated once during a 24 hour period.

Preferably, the pipe segments are sequentially heated.

Preferably, the electrical power supply is configured to heat the wall of the pipe to at least 50° C.

Preferably the method further comprises, for each segment of the pipe being heated, heating with a power of about 15 kW for each 1 m length of the wall of the segment of the pipe that is being heated; and heating with the power for about 120 seconds.

Preferably, the method further comprises, for each segment of the pipe being heated, heating with a power of about 40 kW for each 1 m length of the wall of the segment of the pipe that is being heated; and heating with the power for about 660 seconds.

According to a fourth aspect of the invention, there is provided a cooling system as shown in any of the accompanying figures.

According to a fifth aspect of the invention there is provided a pipe assembly comprising: a pipe; and a heating cable arranged along the length of the pipe; wherein, in use, the pipe is arranged to allow cooling of the outer surface of the pipe by the surrounding environment of the pipe when the outer surface of the pipe is hotter than its surrounding environment.

Preferably, an outer surface of the pipe, or a coating of the pipe, is in direct contact with the surrounding environment of the pipe and, if the pipe has a coating, an inner surface of the coating is in direct contact with the pipe.

Preferably, if the pipe has a coating, the coating is not designed to provide thermal insulation.

Preferably, if the pipe has a coating, the coating is a ceramic.

Preferably, if the pipe has a coating, the coating is one of boron nitride, aluminium nitride, aluminium oxide, chromium nitride, zirconium nitride, boron nitride, dichromium nitride, titanium aluminium nitride, chromium aluminium nitride, and titanium nitride, alkaline earth metal nitrides and alkali metal nitrides, and aluminium thermal spray.

Preferably, no thermal insulation is provided along the length of the pipe.

Preferably, the heating cable is coiled around the outer circumference of the pipe.

Preferably, the heating cable is coiled around one or more sections of the pipe and not coiled around the pipe between the coiled sections.

Preferably, a plurality of separately controlled heating cables are provided.

Preferably, the pipe is an inner pipe and an outer pipe is further provided around the inner pipe.

Preferably, water from the outside of the outer pipe is arranged to flow through between the inside of the outer pipe and the outside of the inner pipe.

Preferably, the flow said water is in counter-current with the flow of a fluid through the inner pipe.

### LIST OF FIGURES

FIG. 1 shows a cooling system according to an embodiment;

FIG. 2A is a cross section of a pipe with a piggy back cable in a known DEH system;

FIG. 2B is a cross section of a pipe with a piggy back cable according to an embodiment;

FIG. 3 shows the effect of the separation between the longitudinal axes of a cable and a pipe;

FIG. 4 shows a cooling system according to an embodiment;

FIG. 5 shows a cooling system according to an embodiment;

FIG. 6 shows a cooling system according to an embodiment;

FIG. 7 shows a cooling system according to an embodiment;

FIG. 8 shows a cooling system according to an embodiment;

FIG. 9 shows a cooling system according to an embodiment;

FIG. 10 shows a cooling system according to an embodiment;

FIG. 11 shows a pipe configuration according to an embodiment,

FIG. 12 shows a pipe configuration according to an embodiment,

FIG. 13 shows a cooling system according to an embodiment,

FIG. 14 shows a cooling system according to an embodiment,

FIGS. 15A and 15B show the junction between a warm flow of fluid and a cooled flow of fluid provided by a return loop and also how seed particles act as a catalyst/nucleate to form larger hydrate particles;

FIG. 16 shows a cooling system according to an embodiment,

FIG. 17 shows a cooling system according to an embodiment,

FIG. 18 shows a cooling system according to an embodiment,

FIG. 19 shows a pipe with a high pressure zone according to an embodiment;

FIG. 20 shows pipe with two cooling elements according to an embodiment;

FIG. 21 shows simulated results of the performance of a cooling system according to an embodiment;

FIG. 22 shows simulated results of the performance of a cooling system according to an embodiment;

FIG. 23 shows a large capacity compact cooling system according to an embodiment;

FIG. 24 is a flowchart of a method according to an embodiment.

FIG. 25 shows a heating cable coiled around a pipe according to an embodiment;

FIG. 26 shows a plurality of heating cables coiled around a pipe according to an embodiment;

FIG. 27 shows a heating cable coiled around a plurality of sections of a pipe according to an embodiment as well as a plurality of heating cables coiled around a plurality of sections of a pipe according to an embodiment;

FIG. 28 shows pipe-in-pipe configurations according to embodiments;

FIG. 29 shows cable configurations according to an embodiment;

FIG. 30 shows cable configurations according to an embodiment; and

FIG. 31 shows a system according to an embodiment.

### DESCRIPTION OF EMBODIMENTS

Embodiments provide a new technique for solving the problem of deposit formation in oil well products.

Embodiments provide a new and advantageous design of cooling system that receives a hot fluid, such as an oil well product, and cools the fluid substantially to the ambient temperature in such a way that deposits are washed along as solid particles in an output flow of cooled fluid rather than forming on the interior surface of the pipes of the cooling system. The cooling system is arranged so that the ambient environment, such as seawater, cools the fluid by conduction and/or convection from pipes carrying the fluid. The pipe walls of the cooling system are periodically heated so that the fluid is mostly cooled by the pipe walls but sometimes heated. The heating releases the solid deposits due to a similar physical effect to that disclosed in US'147. The heating technique of embodiments is through the use of electrical currents through the wall of the pipe. Advantages of the specific heating technique include it being more effective, efficient and less expensive than other heating techniques. In subsea applications, the cooling system is also easy to install on a sea floor.

A preferable embodiment of the cooling system is a compact unit that, in subsea oil extraction applications, would typically be located at, or near to, a subsea wellhead. If the output of the cooling system is substantially at the ambient temperature of the sea water then this allows the output oil well product to be transported as a cold flow. That is to say, the oil well product can be transported over long distances in a pipe network along the sea floor without the need for DEH, or other techniques, to heat the oil well product to prevent deposit formation. The provision of the cooling system as a compact unit allows the flexible re-configuration of the system given the fluid and environmental conditions.

Advantageously the cooling system improves on known pig based systems as substantially no moving parts are required. It also improves on chemical injection systems as there is no need for the cost of the injected chemical or the resulting environmental risks.

Advantages over US'147 are the improved effectiveness, efficiency and low cost of the specific technique used to heat the fluid. Further advantages provided by some embodiments are the provision of the cooling system as a compact unit with flexible operation and re-configuration with improved redundancy, instability, modularity, scalability, retrievability, interchangeability and serviceability

The cooling system according to embodiments is preferably provided as a modular design. This eases the installation and maintenance of the cooling system.

Embodiments cool a fluid flow to, or close to, the ambient temperature. Advantageously, the cooled fluid is more appropriate for long transportation distances as DEH systems are not required downstream. Embodiments therefore provide Cold-flow.

Embodiments are described in more detail below. Although embodiments are described mostly in the context of a subsea cooling system used for the subsea extraction of oil well products, embodiments include a surface based cooling system and also a cooling system for use in other industries.

In particular, other applications of embodiments include the cleaning of pipe separators, pipes in nuclear industries, sewage pipes, heat exchanger pipes, pipes in chemical plants, pipes for refrigerators, pipes for heat pumps, pipes for refineries, separation pipes, pipes for scrubbers, pipes in the food industry and flow assurance systems. Embodiments are generally applicable to applications comprising pipes within which a deposition comprising meltable components can form.

Embodiments are described in more detail below in the exemplary application of a subsea cooler arranged to cool a fluid oil well product at a wellhead.

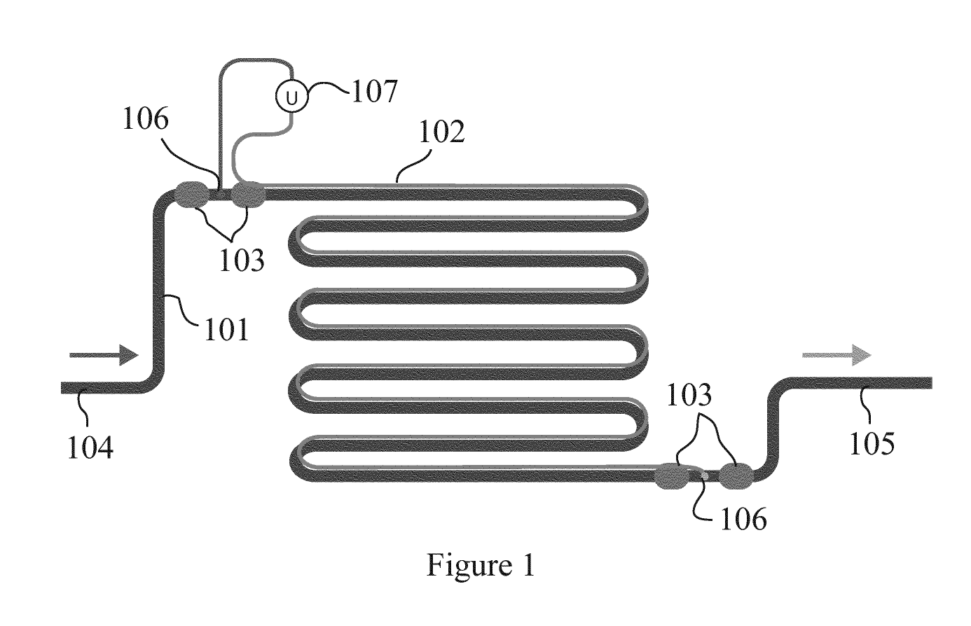

FIG. 1 shows a pipe assembly for use as a cooling system according to an embodiment. As described in more detail below, the pipe assembly comprises a pipe 101, a piggy back cable 102, an inlet 104 an outlet 105, a plurality of electrical connectors 106 of the piggy back cable 102 to the pipe 101, anodes 103 and a power supply 107.

The pipe is a standard pipe as used in subsea applications, in particular known subsea coolers, and may be made of stainless steel or carbon steel. The pipe comprises a number of bends and has a wavelike shape but embodiments also include the pipe being substantially linear.

Attached to the pipe at each end are electrical connectors. The electrical connectors are in electrical connection with the wall of the pipe. The electrical connectors are also attached to an electrical power supply. The electrical power supply is arranged to heat the pipe wall by providing an electric current that flows through the pipe wall between electrical connectors. The electric power supply may be the same as that currently in use in DEH systems and would typically be provided by a cable connection either to a platform on the sea surface or to a nearby onshore facility.

The electric current that is supplied to the pipe wall may be either direct current (DC) or alternating current (AC).

FIG. 1 shows an implementation with an AC power source. As shown on FIG. 1, a cable, referred to as a piggyback cable, is preferably provided from one of the electrical connectors back along the length of the pipe to the power source. The longitudinal axes of the cable and the pipe are substantially parallel to each other. The effect of the piggyback cable with AC currents is that there is an inductive effect between the cable and the walls of the pipe. This, together with the flow of the current through the walls of the pipe, heats the pipe walls. The cable that is used may be a cable from a DEH system.

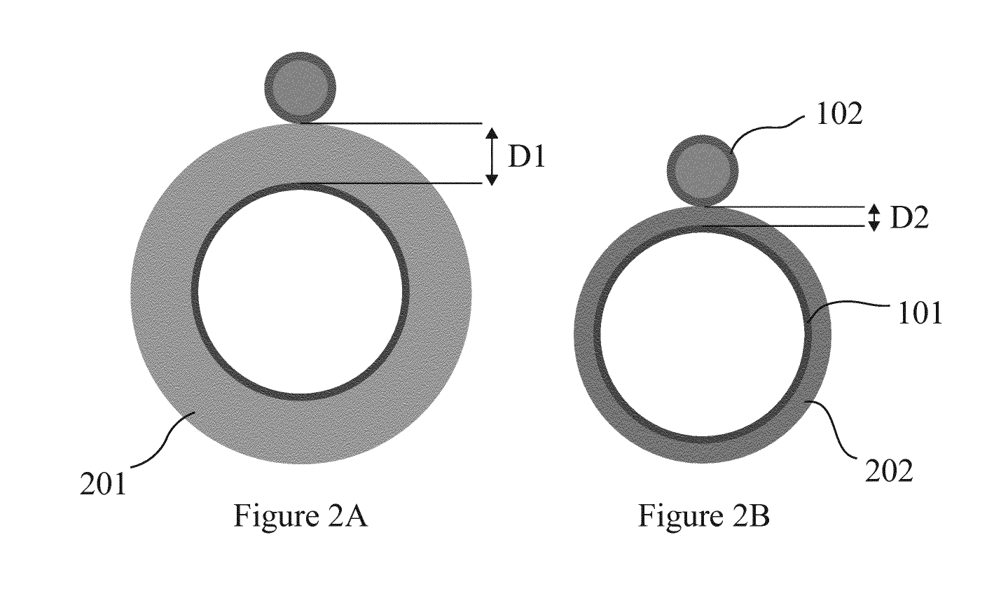

FIG. 2A is a cross section of a pipe with a piggy back cable in a known DEH system with the minimum separation of the pipe wall and piggy back cable being D1. FIG. 2B is a cross section of a pipe with a piggy back cable according to embodiments with the minimum separation of the pipe wall and piggy back cable being D2. A DEH system requires thermal insulation 201. Embodiments do not have thermal insulation around the pipe and instead only have coating 202 that is an electrical insulator. Accordingly, D2 is very much less than D1.

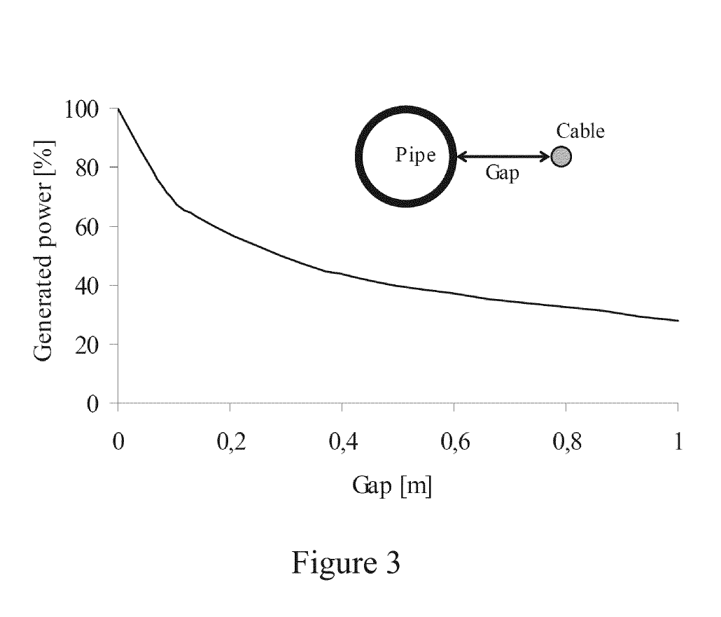

FIG. 3 shows the effect of the separation between the longitudinal axes of the cable and the pipe (the graph is from a publication by SINTEF). The heating effect of the AC current increases as the separation of the longitudinal axes of the cable and the pipe decreases. Accordingly, the cable is preferably arranged to lie along the surface of the pipe, or to have only a small separation from the wall of the pipe, so as to provide efficient heating. This is a significant difference between embodiments and DEH based systems. In DEH based systems there is a motivation to provide a thick layer of insulation/plastic coating around the pipes because it is essential for the pipes to have good thermal insulation. The piggyback cable is provided outside of the insulation due to the practical requirement of how DEH systems are manufactured and installed. Accordingly, in DEH system there is a greater separation between the cable and the wall of the pipe and this decreases the efficiency of the heating. As explained in more detail later, a further significant difference between embodiments and DEH systems is that the pipes according to embodiments are provided with an electrically insulating coating, that has a high thermal conductivity, and is a thin layer on the surface of the pipe. The frequency of the applied voltage to the pipe wall by the electric power source may be the same as that known for DEH systems. However, a lower voltage may be used due to the increased efficiency of the system and the difference between the periodic heating according to embodiments and the continuous heating applied in DEH systems.

If a DC current is used then no piggyback cable is required and each of the electrical connectors can be connected directly to the power supply. Relative to AC heating, the use of DC also reduces the peak voltage that needs to be applied to the pipe wall in order to heat with a particular electric power. An advantage of wavelike structures of the pipe, such as shown in FIG. 1, is that the electrical connectors can be designed close to each other and only a small amount of cable to the electric power source is required. However, a disadvantage of a DC power supply is that the power supply is typically provided from an AC power source. For a DC electric current to be provided a rectifier is therefore required to convert the AC to DC. The rectifier may be located either at the surface or subsea as part of the cooling system. Although using DC avoids the use of a piggyback cable, the use of rectifier increases costs and introduces power losses.

Between each electrical connector are anodes. These are sacrificial anodes for helping to prevent the corrosion of the pipe and reducing the detrimental effects caused by passing an electric current through the pipe wall. The anodes may be the same as the anodes that are currently in use in DEH systems.

The anodes are preferably in a direct electrical connection to the metal pipe wall and the pipe coating is therefore not provided between the pipe wall and each anode or over the anodes. Alternatively, an anode bank may be provided close to the pipes of the cooling system and electrically connected to the pipe by a cable. An advantage of an anode bank is easier to design it to be retrievable and replaceable.

The pipe is coated with a material that preferably has all of the properties of providing corrosion resistance, having a high thermal conductivity and having a high electrical resistance. The coating preferably also provides mechanical protection and a smooth surface that is easy to clean and resists marine growth. Suitable coatings include ceramic materials. A particularly preferred coating according to embodiments is boron nitride. Boron nitride has the advantages of being inexpensive, providing a hard surface, being easy to apply already very widely used across a number of industries. It has a high thermal conductivity (typically 266-284 W/m-K), a high electrical resistivity (typically 1.00e+15 ohm-cm), and provides good corrosion protection. It is a ceramic material that can be used either alone or in combination with other materials or resins.

Embodiments include the use of other coating materials, such as aluminium nitride, aluminium oxide, chromium nitride, zirconium nitride, dichromium nitride, titanium aluminium nitride, chromium aluminium nitride, and titanium nitride, alkaline earth metal nitrides and alkali metal nitrides, ATS (aluminium thermal spray).

The most appropriate way of applying the coating material to the pipe will depend on the coating material used. Typical coating techniques, that are all known for the coating of pipes with such materials are painting, powder coating, electrolysis, extrusion, moulding, wrapping, lamination, weaving and thermal spraying.

The pipe is in a subsea environment and is configured so that substantially all of its outer surface is surrounded by seawater. The ambient temperature of the surrounding environment of the pipe may be about 4° C. to 5° C. The fluid output from a well head may be at 60° C. to 80° C. of higher. By arranging the pipe to be surrounded by the seawater, and for the pipe to have a thermally conductive coating, the walls of the pipe are cooled by conduction to the seawater and convection of the seawater and the fluid in the pipe is therefore cooled to the ambient temperature.

The coating need only be thick enough to provide the desired electrical insulation, corrosion and strength properties and embodiments include the coating being no thicker than a standard coating of a pipe for most subsea applications. Advantageously, the coating is thin and this has the combined effect of both allowing fast cooling of the walls of the pipe due to the low thermal insulation and also, in embodiments in which a piggyback cable is used, high heating efficiency due to the thin coating allowing only a small separation between the cable and the pipe wall.

A cooling system according to embodiments may comprise just a single pipe with electric heating system as described above. The at least one pipe of the cooling system is arranged in the seawater so that it is cooled to the ambient temperature of the environment.

A fluid, that may be directly received from a wellhead or from another subsea system, flows into a pipe of the cooling system. Most of the time, no heating of the fluid is applied and the fluid is cooled to below the deposit forming temperature and deposits are allowed to build up on the inner walls of the pipe. The length of pipe is preferably such that fluid output from the cooling system has been cooled substantially to the ambient temperature. In order to remove the deposits from the inner surface of the pipe walls, the pipe walls are occasionally heated by the electric power source. The heating is preferably to a temperature that is sufficient to cause the deposits to be removed from the inner walls but not high enough to melt any of the waxes in the deposit. By not melting the waxes the reforming of the deposits on the inner walls of the pipe further downstream is unlikely to occur and the deposits will remain as solid particles in the fluid stream.

Advantageously, the cooling system according to embodiments improves on known cooling systems. No pig or injection of chemicals is required. In addition, the direct heating the pipe walls by an electric current is more efficient and effective than the heating techniques disclosed in US'147.

Raw production fluid basically consists of water, gas, condensate sand and oil. In some cases the water cut is quite high (e.g. during late production of a well and in certain areas) and has no value. In such cases it would be beneficial to remove the water before cooling the flow. This can be done using a separator in front of the cooler (gravitational, cyclone, pipe separator). The water has high heat capacity and will make the flow harder to cool. Reducing the amount of water will be beneficial in several ways; it will result in a shorter and more compact cooler, it will make long distance transportation easier because less pressure is needed to move/lift the lighter flow, and there will be less hydrate formation (Hydrates consist of water and gas). The removed water can be re-injected in a reservoir or used as pressure support in the well. This is not currently known in combination with a subsea cooler.

In other embodiments, gas can also be separated out of the flow. This can be beneficial for faster cooling of the liquid hydrocarbons, and also reduce the amount of hydrates that can form.

Some of the gas in the cooler will condensate when cooled and turn into liquid hydro carbons. This effect of the cooler is improved if there is subsea compression or boosting of the flow. The dryer gas that is separated out can be boosted without damaging the compressors and the stabile liquid is easier to pump without gas. The cooler will in this embodiment be placed in front of a gas-liquid separator.

Some separators are called pipe separators. They are gravitational separators made from large standard subsea pipes that can handle great pressure. The flow in these separators must be slow and non-turbulent for the flow components to separate effectively. Wax and hydrates may form in this situation because of pressure drop or cooling. The same cleaning system described for embodiments of the cooling system also applies for pipe separators and the pipe separators may be occasionally heated to remove deposits. Such a separator can be seen as a segment of embodiments of the the cooling system or even integrated within the cooling system.

The pipes of the cooling system according to embodiments may be made of ASTM A106 GR.B/carbon steel or similar materials. The inner diameter of the pipes may be in the range 5.08 cm to 30.48 cm (i.e. 2″ to 12″) or larger. The wall thickness of the pipe may be according to ASTM A106 gr.B. The total length of pipe may be in the range of approximately 300 m to 6000 m and is preferably in the range 300 m to 1000 m.

For systems using smaller pipes with a diameter of about 50.8 mm to 101.6 mm, i.e. 2″ to 4″, the internal flow will be more turbulent. A smaller pipe also has more cooling surface area compared to cross section area. Together this will make the cooling process more effective. A plurality of parallel smaller cooling systems with small pipes will therefore be more effective than a single cooling system with a larger diameter pipe and the same capacity as the plurality of smaller cooling systems.

Another effect of a turbulent flow is a process where dry hydrates that have formed will “bead blast” the inner walls and clean off much or all of the wax deposits. This effect will reduce and sometimes remove the need for external heating for wax deposit cleaning. Not all fields will have the ideal composition between hydrates and wax, but this effect is beneficial in many cases.

Smaller cooler modules will also be easier to install since a smaller crane vessel is needed. The modularity also makes the total installation more scalable and flexible to fit the changes in production flow during a field's lifetime and possible new tie-ins.

The embodiment as shown in FIG. 1 has a power supply that is arranged to heat the entire length of the pipe assembly when it is operating and to not heat any of the pipe assembly when it is not operated.

Embodiments include the use of a switching system that advantageously allows sections of the pipe assembly to be heated independently of the other sections of the pipe assembly. The control over which sections of the pipe assembly are heated allows more efficient operation of the system. The power source can be operated continuously and at a lower power than if the entire length of pipe is heated. In addition, each of the consecutively heated sections can be heated faster than if the entire length of pipe is being heated.

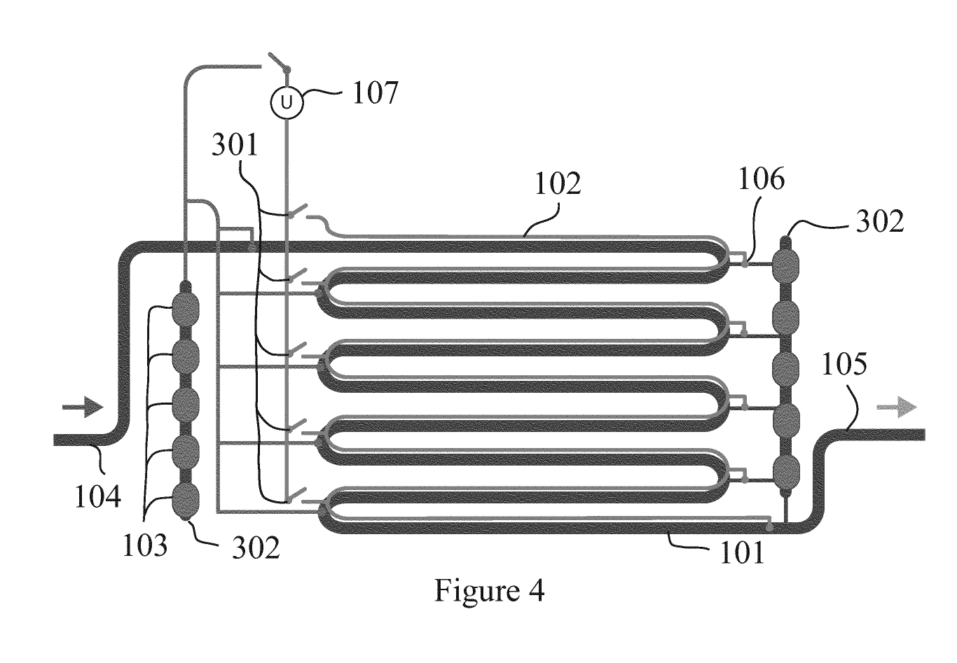

FIG. 4 shows a pipe assembly with a piggyback cable, so that it is configured for heating by an AC power supply, with switches 301 that control which sections of the wavelike pipe shape are heated according to an embodiment. The anodes are provided in an anode bank 302.

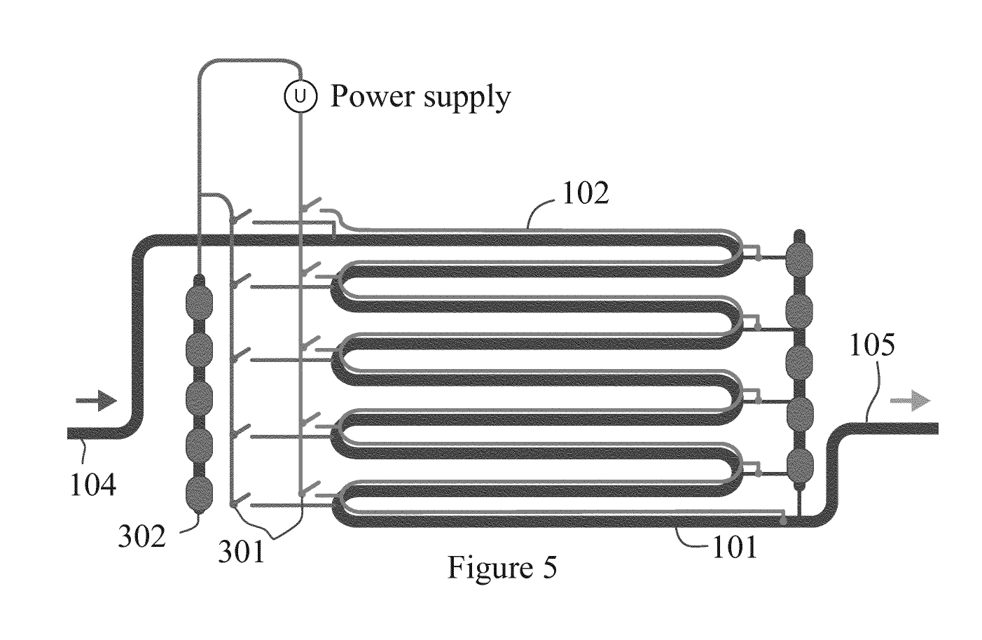

FIG. 5 shows a pipe assembly with a piggyback cable with switches that control which sections of the wavelike pipe shape are heated according to another embodiment.

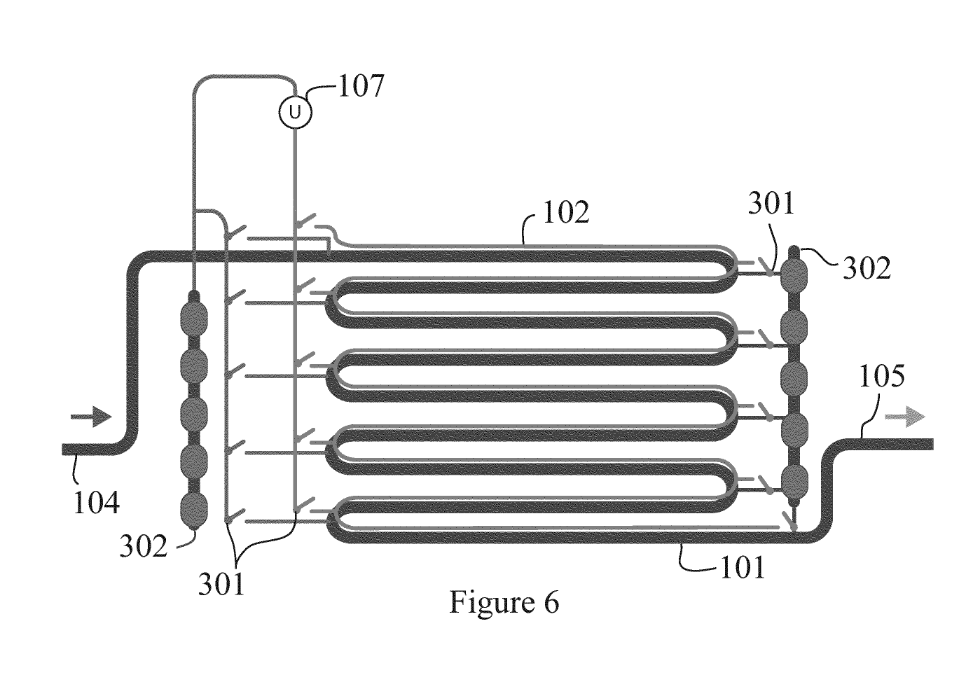

FIG. 6 shows a pipe assembly with a piggyback cable with switches that control which sections of the wavelike pipe shape are heated according to another embodiment.

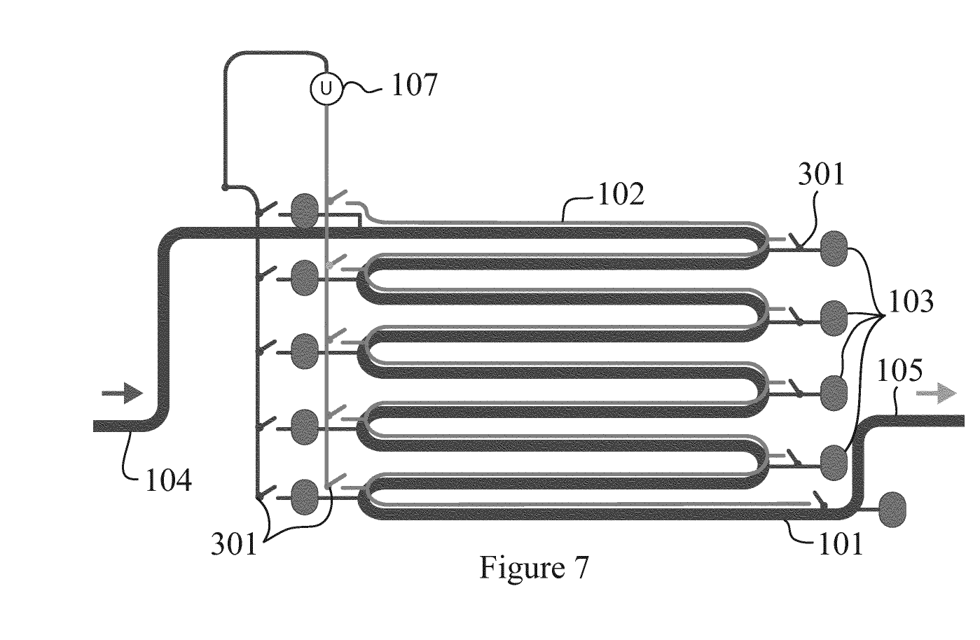

FIG. 7 shows a pipe assembly with a piggyback cable with switches that control which sections of the wavelike pipe shape are heated according to another embodiment. The anodes are provided separately rather than being connected together in an anode bank.

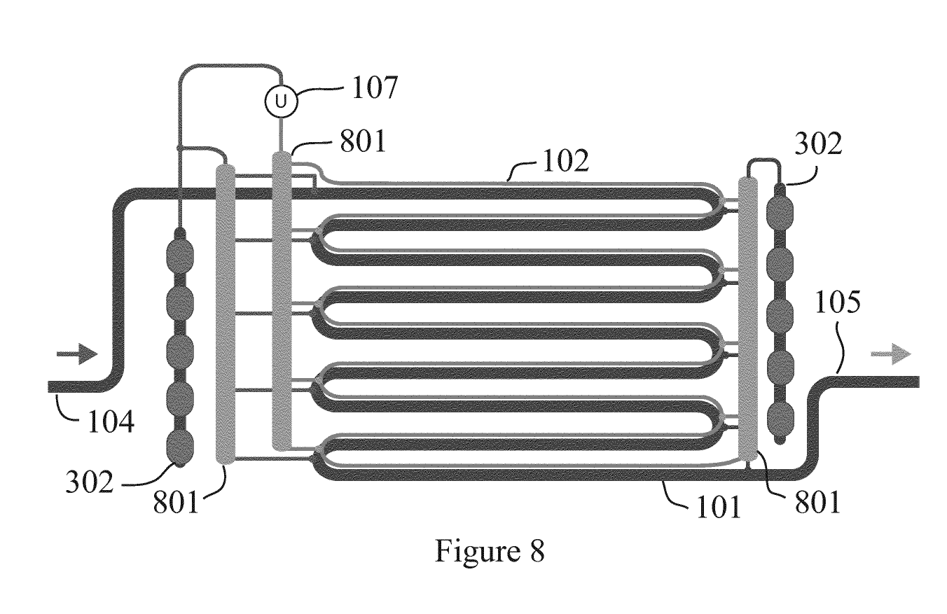

FIG. 8 shows a pipe assembly according to another embodiment. The pipe assembly corresponds to that in FIG. 7 but the switches are provided in switch boxes 801.

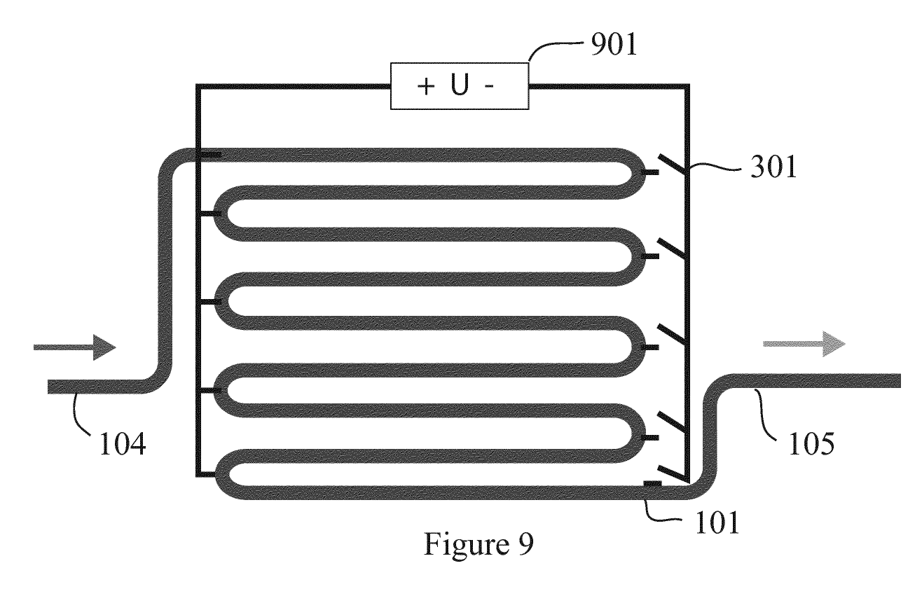

FIG. 9 shows a pipe assembly according to another embodiment. The pipe assembly is only configured for heating by a DC power supply 901 and switches are provided to control which section(s) of the pipe assembly are heated at any particular time.

In FIGS. 4 to 9, either anodes or anode banks are provided close to the pipe system Embodiments also include all of the pipe systems disclosed herein alternatively having anodes directly connected to the pipe walls. The embodiment shown in FIG. 9 also has anodes, that are either directly connected to the pipe or provided by a separate anodes or an anode bank, though these are not shown in FIG. 9.

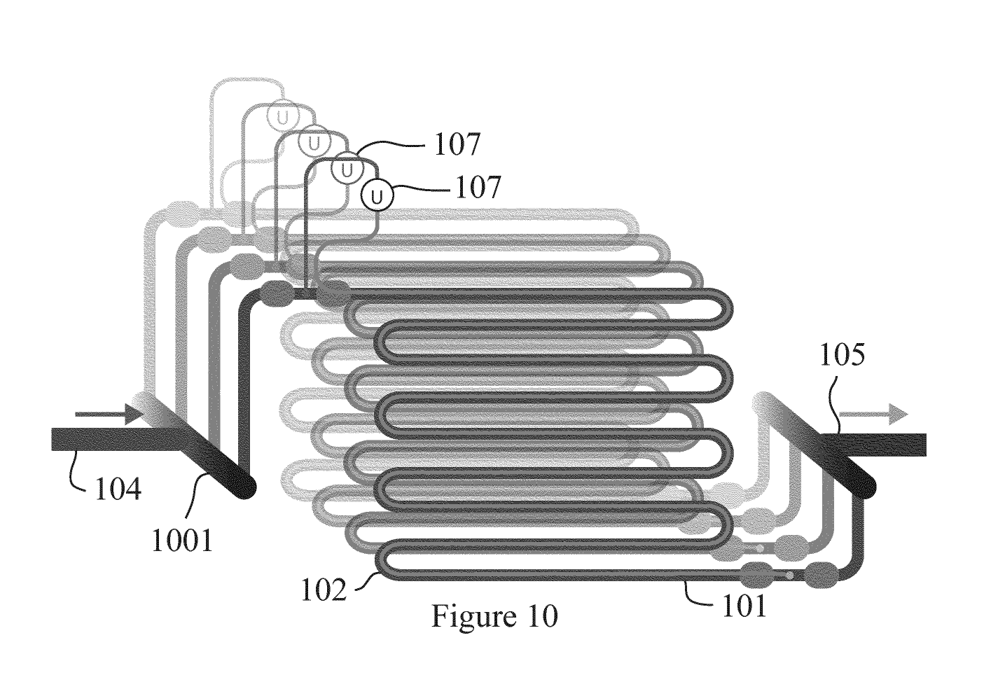

FIG. 10 shows an embodiment of the cooling system that comprises a plurality of pipe assemblies. The cooling system has a single input port through which a fluid flows. A splitter, or manifold, 1001 then splits the fluid into a plurality of fluid flows that each flow into a different pipe assembly. The pipe assemblies, which each may be any of the above-described pipe assemblies that are shown in FIGS. 1 and 4 to 9, are arranged in parallel planes with each other, i.e. they in a stacked configuration. The fluid output from each pipe assembly flows into a combiner that combines all of the fluid flows. The single fluid flow output from the combiner is the output fluid flow from the cooling system.

The system preferably comprises valves arranged to control which of the pipe assemblies an input fluid flow can flow into. Advantageously, the cooling system can be reconfigured and is adaptable to different fluid flows.

Although FIG. 10 shows the system with each pipe assembly having its own power supply, embodiments preferably have the same power supply providing power to each pipe assembly. A switching system allows the heating of each pipe assembly to be controlled independently of the other pipe assemblies.

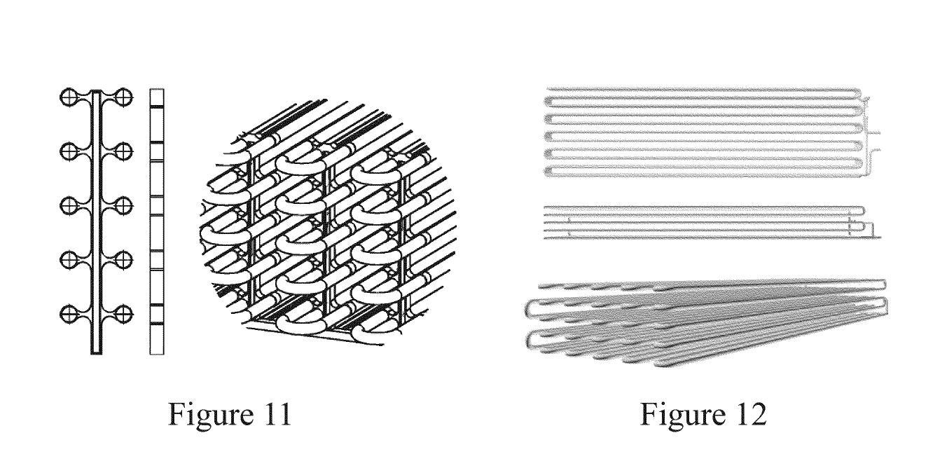

FIG. 11 shows how the stacked configuration of pipes is preferably provided. The spacing between the pipes allows convection currents to form and these increase the rate at which the pipes are cooled.

FIG. 12 shows another cooling system according to embodiments. As in FIG. 10, the cooling system comprises a plurality of wavelike pipe assemblies arranged in parallel planes. The embodiment shown in FIG. 12 differs from that in FIG. 10 in that there is no splitter or combiner. The input fluid flow to the cooling system is only input into one of the pipe assemblies. A pipe connects the output of that pipe assembly with the input of another pipe assembly, the output of which is similarly connected by a pipe to the input of another pipe assembly and so on until the fluid flow is output from the cooling system without ever being split or combined. This embodiment is a cheaper and easier implementation of a cooling system one with a splitter, combiner and valves.

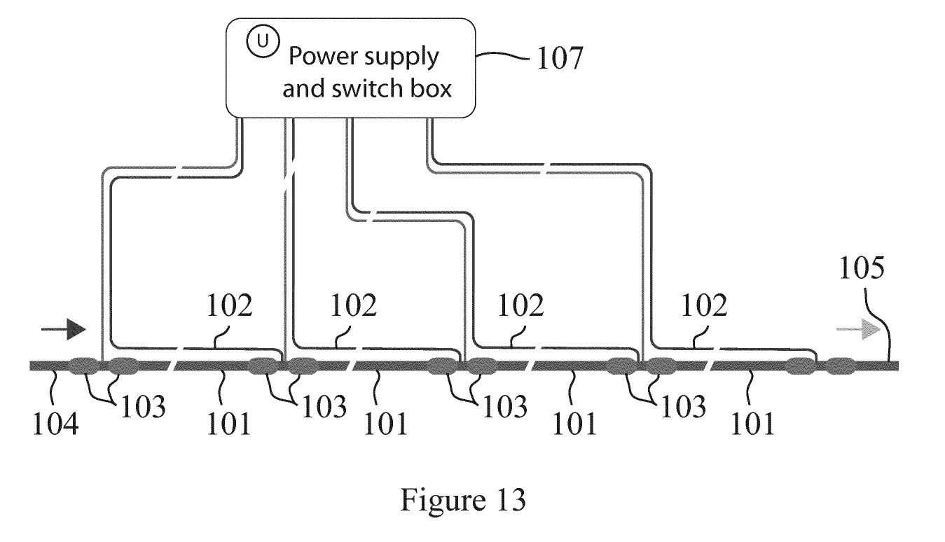

FIG. 13 shows another cooling system according to embodiments. In FIG. 13 the pipe assemblies are all linear and they are arranged co-linearly with each other. A switching system is provided that allows the heating of the pipe assemblies to be individually controlled. The cooling system may either be formed by combining a plurality of linear pipe assemblies or by providing the anodes and electrical connections on a single length of pipe in a way that creates a plurality of sections along the length of pipe wall through which an electric current can flow. Each of the sections is preferably about 100 m long.

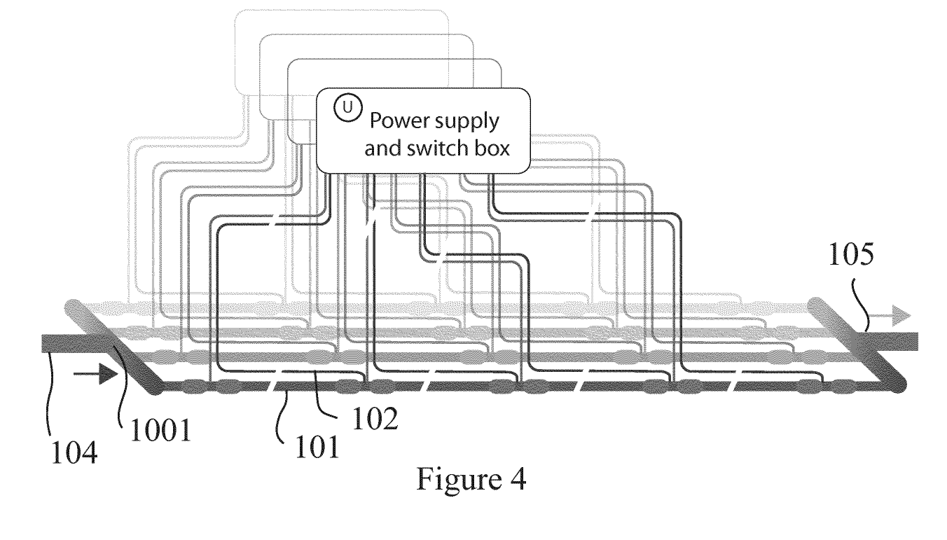

FIG. 14 shows another cooling system according to an embodiment. The cooling system comprises a plurality of the cooling systems with a plurality of co-linear pipe assemblies as shown in FIG. 13. The plurality of co-linear pipe assemblies are arranged alongside each other and in the same plane. The cooling system has a splitter for splitting the input fluid flow into flows into each of the co-linear pipe assemblies and a combiner for generating a single output flow from the cooling system from the output fluid flows from the plurality of co-linear pipe assemblies. Preferably a valve system is provided for controlling which of the pipe assemblies the input fluid can flow through. Preferably a single power supply provides all of the heating and the heating of each section of each pipe assembly can be individually controlled.

Embodiments include other configurations of cooling system. For example, embodiments include a cooling system that comprises a plurality of the cooling systems as shown in FIG. 14 in a stacked configuration. Embodiments also include a cooling system that comprises both linear and wavelike pipe assemblies.

The stacking of the pipe assemblies, and the use of wavelike pipe assemblies, allows for a compact cooling system to be provided. The cooling applied to the input fluids increases with the length of pipe that the fluid passes through. By providing a compact cooling system and large amount of cooling can be provided by the cooling system.

Embodiments also include modifications to the above-described pipe assemblies so as to include a return loop, or retour loop, in the pipe assembly. Return loops are disclosed in, for example, https://www.sintef.no/en/projects/saturn-cold-flow/, as viewed on 26 Jan. 2016.

The return loop might also be fitted with a heat cleaning system so that the return loop is occasionally heated to remove any deposits that have formed therein.

Seed crystals of hydrate particles are used to kick-start crystallisation/formation of wax and hydrates and thereby reduce the length of the system. This is done by shock cooling of the fluid input to the cooling system by mixing it with fluid from the output of the cooling system that comprises seed particles. A pipe and valve system is further provided as a return loop of fluid output from the cooling system to fluid input to the cooling system.

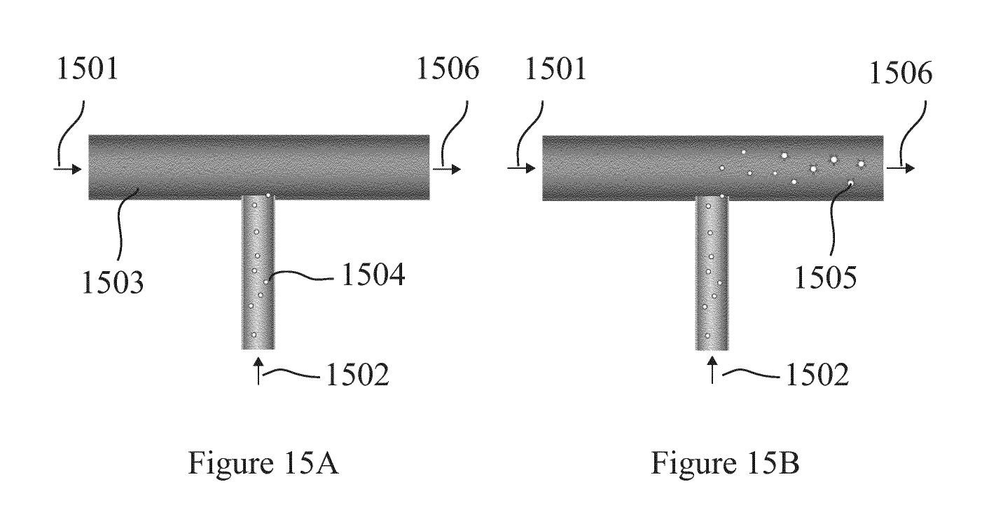

FIGS. 15A and 15B show the junction between an input warm flow 1501 of fluid 1503 at an inlet of the pipe assembly and a cooled flow 1502 of fluid provided by the return loop from the outlet of the pipe assembly.

In FIG. 15A, the fluid comprises material that can form deposits, which in a flow of oil may include water particles and gas 1504. The cooled flow comprises a dry hydrate particles and is a slurry. As shown in FIG. 15B, the mixing of the dry hydrate particles with the particles in the warm flow accelerates the formation of the particles in the warm flow into dry hydrate particles 1505 within the flow to outlet 1506.

Advantageously, the rate of formation of particles within the flow is increased and the efficiency and effectiveness of pipe system at preventing deposits from forming is increased.

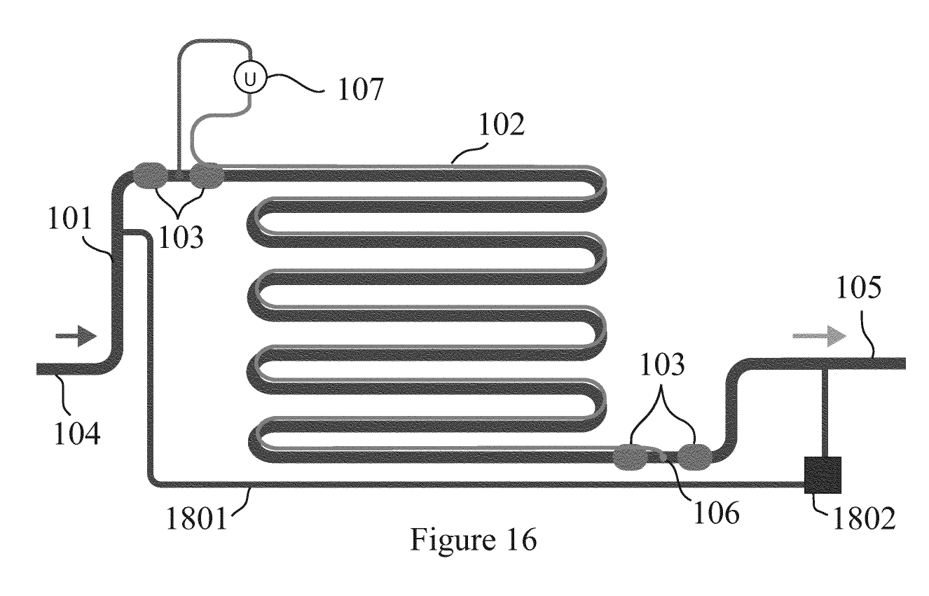

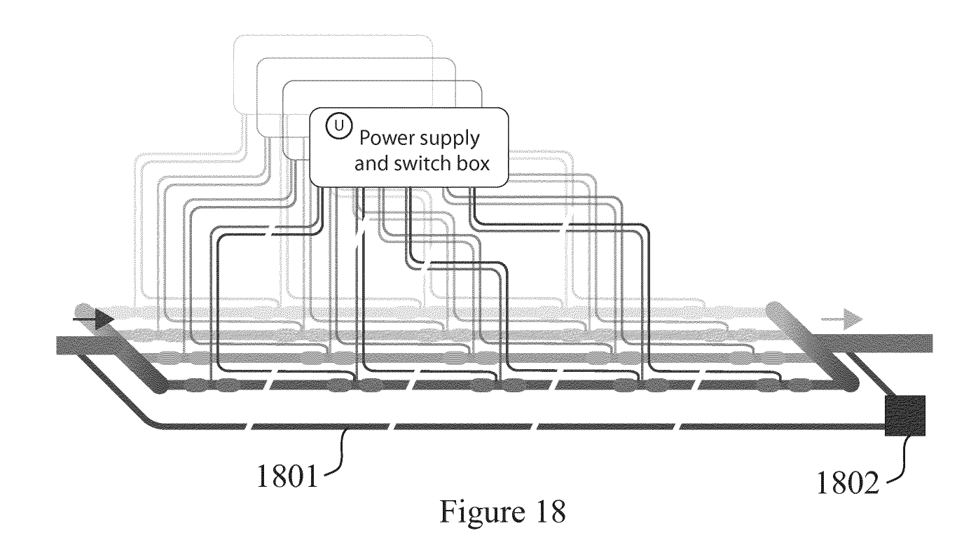

All of the embodiments of pipe assemblies may be adapted to comprise a return loop. For example, FIGS. 16, 17 and 18 respectively show the pipe assemblies of FIGS. 1, 10 and 14 adapted to comprise a return loop 1801.

Pump 1802 is provided to pump part of the fluid from the output of the pipe assembly back to the input.

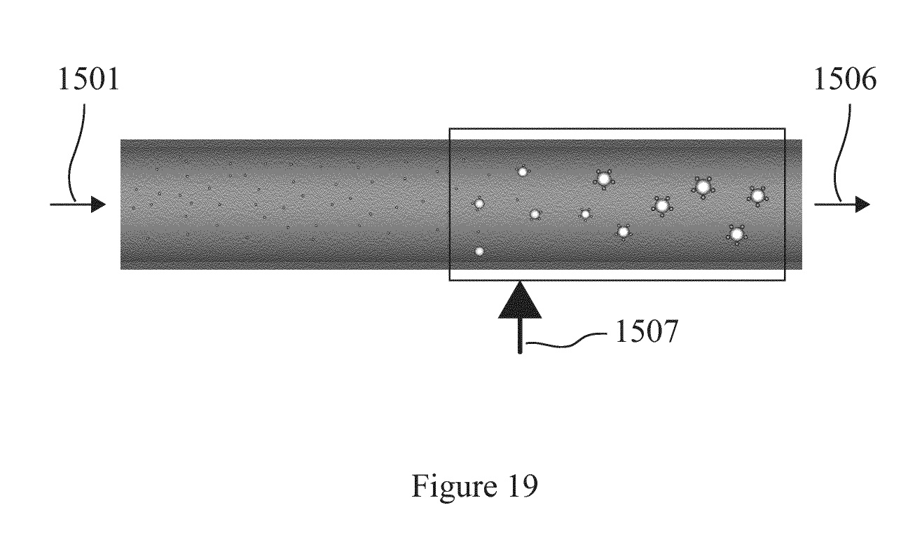

FIG. 19 shows an alternative embodiment for accelerating the formation of dry hydrates within the flow that may be applied in addition to, or instead of, a return loop. The pipe comprises a zone 1507 within which the pressure is increased. The pressure increase may be provided by, for example, a pump or narrowing of the pipe. The effect of increasing the pressure is to accelerate to formation of dry hydrate particles.

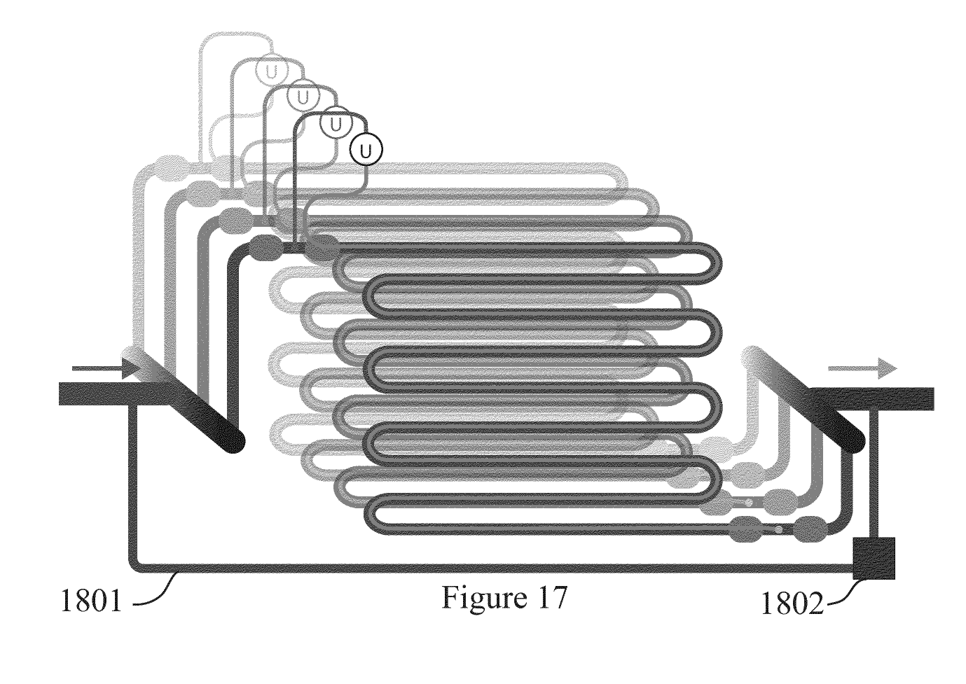

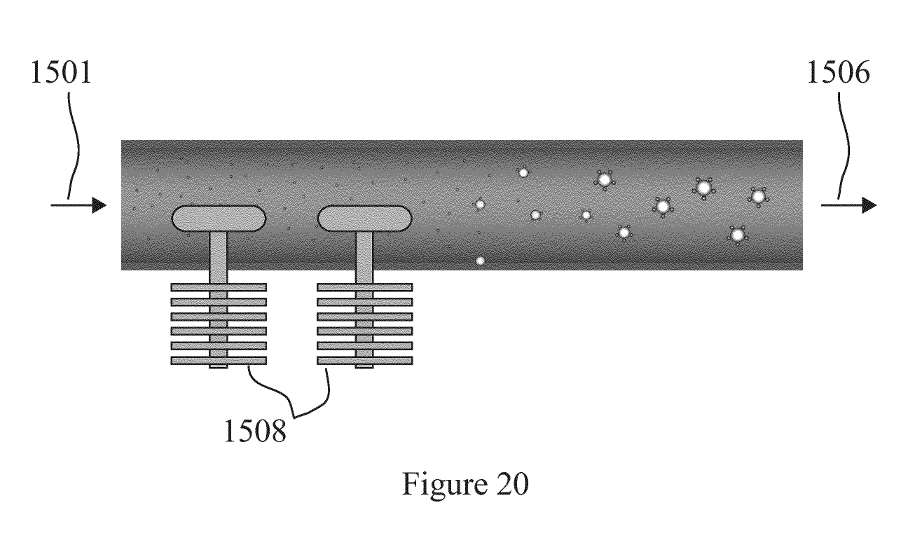

FIG. 20 shows an alternative embodiment for accelerating the formation of dry hydrates within the flow that may be applied in addition to, or instead of, a return loop. Provided within the flow are one or more cooling elements 1508. The cooling elements may be passive and have, as shown in FIG. 17, a cooling finger in the flow path and a heat sink that is cooled by the external environment of the pipe. Alternatively, the cooling elements may be active. An active cooling element would provide faster cooling than a passive cooling element and can also cool to a temperature below the surrounding environment of the pipe. The effect of the cooling is to accelerate formation of dry hydrate particles.

Embodiments also include any of the above described cooling systems being installed on supports, or stilts, so that the cooling systems are raised from the seabed. This prevents the seabed acting as a thermal insulator on the lower surface of the pipe assembly and increases rate of cooling by increasing the flow of sea water through the cooling system.

Simulations have been performed to demonstrate the performance of the cooling system described herein. The pipes were made of ASTM A106 GR.B/carbon steel. The wall thickness of the pipe is according to ASTM A106 gr.B. The simulation packages used to obtain a power consumption analysis and other results were UNIGRAPHICS NX NASTRAN and Excel.

The cooling system was simulated with an input fluid temperature of 80° C., an ambient water temperature of 4° C. and a fluid flow rate of 1 m/s.

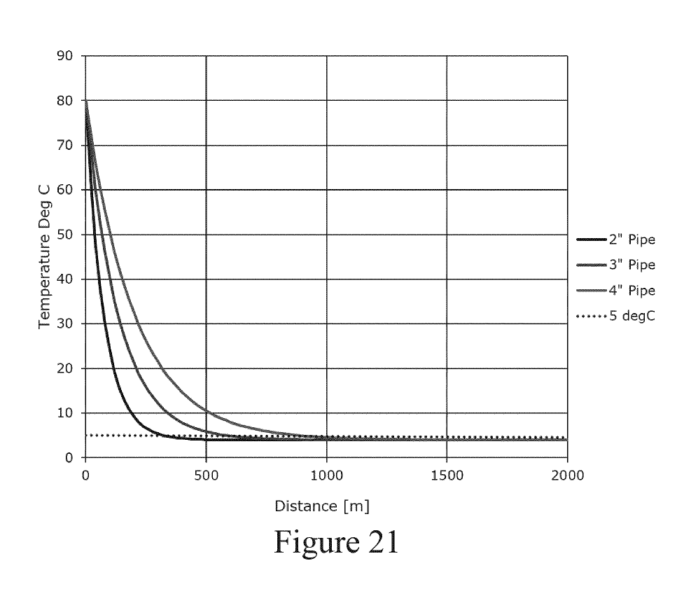

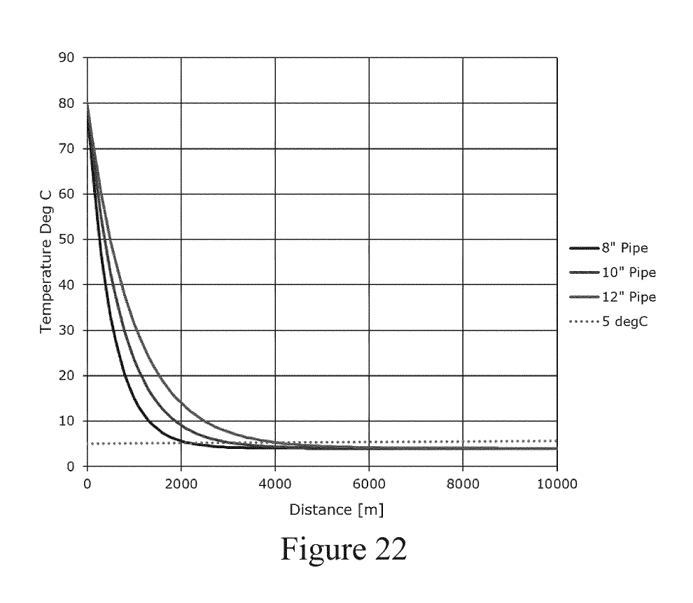

FIG. 21 shows the results of simulations of the pipe assembly according to embodiments with pipe inner diameters of 5.08 cm, 7.62 cm and 10.16 cm (i.e. 2″, 3″ and 4″). FIG. 22 shows the results of simulation of the pipe assembly according to embodiments with pipe inner diameters of 20.32 cm, 25.40 cm and 30.48 cm (i.e. 8″, 10″ and 12″).

The required length of the pipe(s) in the cooling system was modelled given the requirement that an input fluid at 80° C. is cooled to 5° C. with enough periodic/interval heating being applied through the cooling process to cause deposits that have formed on the inner surface of the pipe to be released as solid particles with a low likelihood of re-forming on the inner surface of the pipe. The simulations were performed for a straight length of pipe. A stacked cooling system design would have a greater cooling effect than that for a linear pipe and therefore lower lengths of pipe are expected to achieve the cooling.

The fastest cooling is achieved with the lowest diameter of pipe and a 5.08 cm of pipe was simulated to have a required total length of 350 m. Pipes with a larger diameter require a longer length of pipe to substantially reach the ambient temperature but they have a larger capacity.

A typical heating arrangement would comprise parts of the cooling system being periodically heated for a short length of time every 24 hours. The heating is preferably performed only once every 24 hours but embodiments also include the heating being performed more than once every 24 hour period. Preferably, the parts are sequentially heated. An advantage of sequentially heating different parts of the system is that the power source can be operated continuously with a substantially constant power demand on the power source.

The rate at which deposits build-up is dependent on the specific circumstances and properties of an oil well product and will typically be in the range of 3-6 mm/week. The on/off times of the heating are preferably adjustable. Accordingly, the on/off times of the heating can be made dependent on a measured, or estimated, deposit build-up rate. This results in an energy saving as heating in substantial excess of what is required is avoided.

Finite Element Analysis was performed to determine to simulate the required power to heat a pipe from an ambient temperature of 5° C. to a target temperature of 50° C.

The simulation was performed with the following conditions:
Pipe material was ASTM A106 GR.B/carbon steel;
Inlet fluid flow temperature: 5° C.
Ambient water temperature: 5° C.
Target temperature was 50° C. on the inner wall of the pipe in order to remove deposits
Flow rate: 1 m/s
Inner wall deposits: 1 mm wax layer

For a 7.62 mm, or 3″, pipe diameter, that is 100 m long, a power of 1.49 MW for 112 s is required for a 50° C. temperature of the inner wall of the pipe

For a 25.4 mm, or 10″, pipe diameter, that is 100 m long, a power of 3.5 MW for 492 s is required for a 50° C. temperature of the inner wall of the pipe

For a 304.8 mm, or 12″, pipe diameter, that is 100 m long, a power of 3.57 MW for 660 s is required for a 50° C. temperature of the inner wall of the pipe

Increasing the applied power will allow shorter heating times.

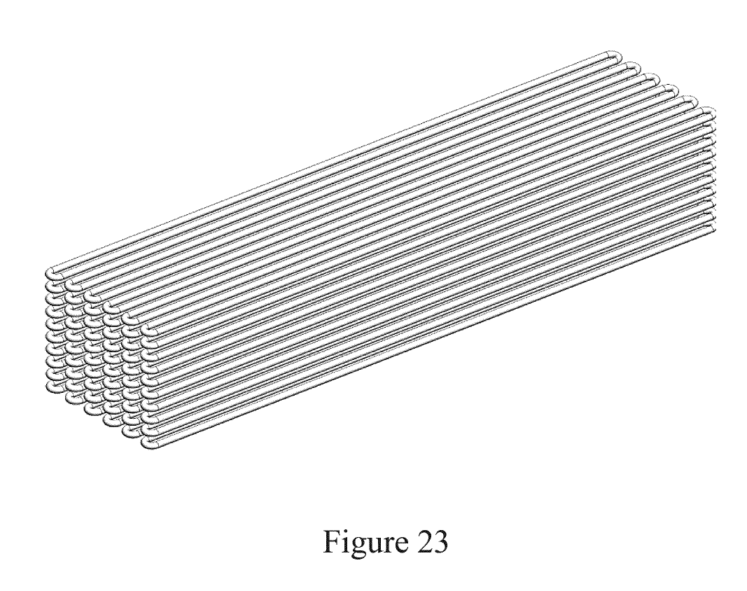

FIG. 23 shows an embodiment of a large capacity compact cooling system according to an embodiment. There is a single pipe through the system and no splitter or combiner are used. The pipe has an inner diameter of 30.48 cm. the total length of the pipe is approximately 5000 m. The dimensions of the cooling system are 10 m wide, 7 m high and 40 m long. The mass of the cooling system would be about 1700 tonnes. The pipe can be heated with either a DC power supply or, with a piggy cable provided, an AC power supply as described above. Embodiments also include large capacity compact cooling systems with alternative dimensions to those of the system shown in FIG. 23.

A particular preferred embodiment is for an input flow to the cooling system to be split into a plurality of smaller flows with each of the smaller flows cooled by a pipe with a relatively small diameter, such as 5.08 mm or 7.62 mm. The effectiveness of the cooling increases as the pipe diameter decreases and such the present embodiment is more effective than a cooling system with the same capacity but implemented by a single larger diameter pipe. In addition, in small diameter pipes, turbulent flow increases the cooling efficiency and solidified hydrate/wax effectively ‘sand blasts’ the inner wall of the pipe and increases the cleaning efficiency.

In the event of plugs occurring in a pipe, the heating mechanism of embodiments can be operated so that the plugs are removed. Plugs may occur following a system shutdown, stops in production, etc. When the production is resumed, embodiments allow cleaning of an entire cooling system to ensure an efficient start-up.

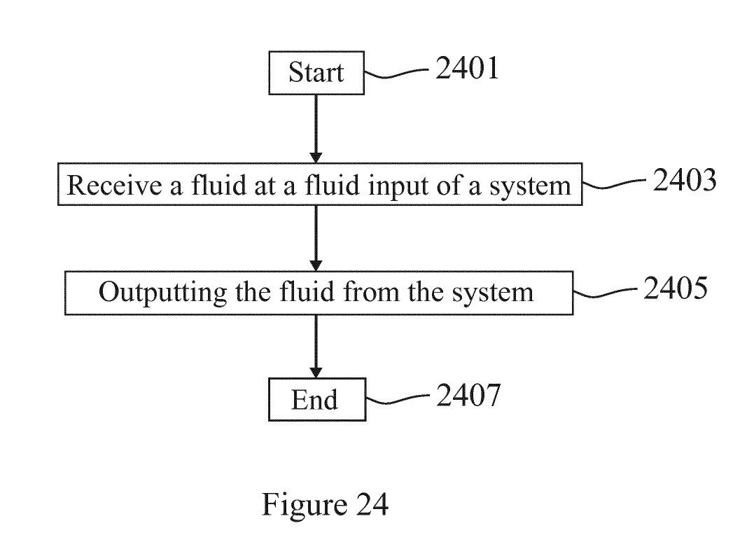

FIG. 24 is a flowchart of a process according to embodiments.

In step 2401, the process begins.

In step 2403, a fluid is received at a fluid input of a system according to embodiments.

In step 2405, the fluid is output from the system.

In step 2407, the process ends.

A further embodiment of the invention is described below.

In the present embodiment, the heating of pipe wall is performed by a heat emitting cable that is provided along the outer surface of the pipe. The heat emitting cable is preferably coiled around the outer circumference of the pipe but may alternatively not be coiled and in a similar configuration to the cable of the previous embodiments. In the present embodiment, the same technique of removing debris from the inner wall of the pipe by heating the pipe wall as described in previous embodiments is applied. However, the present embodiment differs from previous embodiments in the way that the pipe is heated. In the present embodiment, the pipe still has a thermally conductive, and possibly also electrically insulating, coating for the efficient cooling/heating of pipe segments as well as the other properties of the pipes and cooling system as described in previous embodiments. The dimensions of the pipe and lengths of heated pipe sections may be as described in previous embodiments. The length of the pipe segments may be up to 6000 m as in previous embodiments but the length of the pipe segments is preferably up to 300 m. The present embodiment can be implemented in the same configurations as described in previous embodiments. For example, the pipes of the cooling system may be elevated, stacked pipes.

In the present embodiment the heating is not by inductive heating but instead by a heat emitting cable, i.e. heating cable, which is coiled around the outside of a pipe in order to directly heat the pipe wall. Segments of a pipe, or an entire pipe, are occasionally heated in order to remove any wax (and other debris) that has built up on the inside of the pipe. Segments of the pipe have a coating that is thermally conductive. The coating may also be electrically insulating. When the pipe segments are heated by the heating cable, any wax and hydrate debris formed on the inside of the pipe is removed and transported by the production fluid flow.

The heating cable is coiled around the pipe. The spacing of the coils is such that there is efficient cooling of the pipe flow when the heating cable is turned off and not heating the pipe wall.

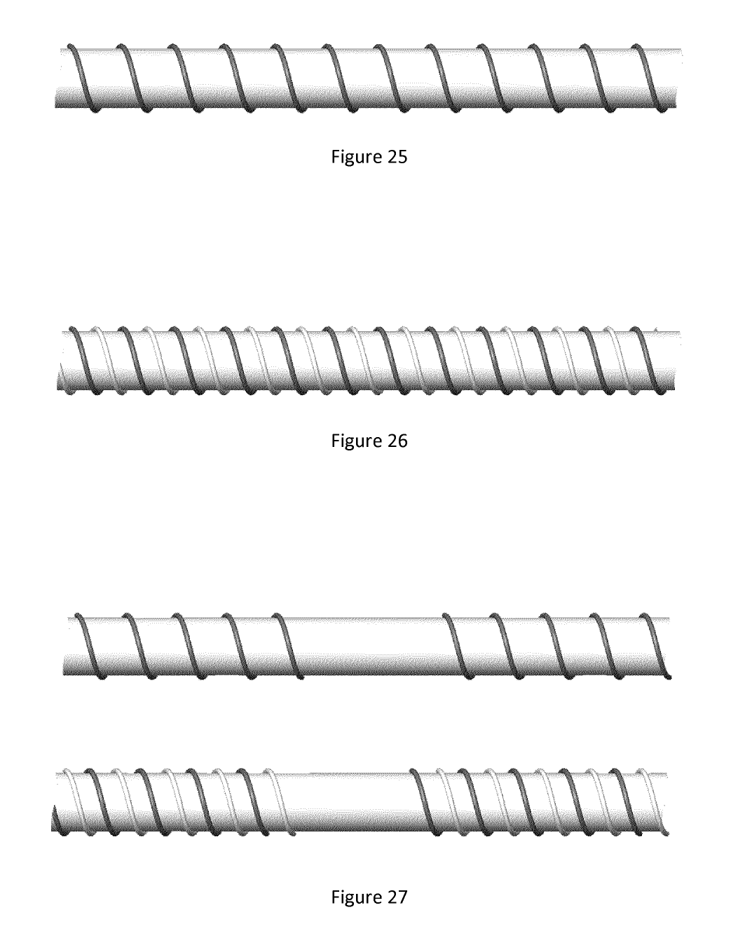

FIG. 25 shows a heating cable coiled around the outer circumference of a pipe segment according to the present embodiment. The separation of the coils ensures that the pipe can be efficiently cooled.

In an alternative implementation of the present embodiment, a plurality of two or more heating cables are used to heat the pipe as shown in FIG. 26. The heating cables are preferably in a coiled configuration around the outer circumference of the pipe but may alternatively not be coiled. The heating of each of the plurality of heating cables is independently controlled so that the amount of heating that is applied can be varied by controlling how many of the heating cables are heated. Advantageously, the system can provide the different heating requirements that may be required throughout the lifetime of the reservoir and changes in temperatures of the production fluid and environment. Having a plurality of heating cables also provides the cooling system with redundancy and a longer design life as the heating requirements of each individual cable are reduced and heating can still be provided if one of the heating cables fails. Each of the plurality of cables may have the same heating power or the heating powers that each cable can provide may be variable. Embodiments also include the heating cables overlapping each other and/or being wound around each other.

The fluid output from the cooling system is preferably cooled to about the ambient temperature. In order to remove the wax in pipe segments of the cooling system, one or more of the heating cables is switched on through a control system. During the heating period, the fluid flowing in the heated section will not be cooled. To ensure that the fluid output from the cooling system is still at about the ambient temperature when heating is applied, the number of pipe sections that are not heated preferably exceeds the number of pipe sections that are heated as appropriate for ensuring that the fluid output from the cooling system is at about the ambient temperature.

Implementations of the present embodiment also include the length of the segments of pipe that are heated being less that pipe segments in the cooling system. As shown in FIG. 27, there may be a plurality of coiled sections of heating cables along a linear section of pipe. The coiled sections, that may be provided by different heating cables, may be activated sequentially in order to remove wax and hydrate deposits on the inner pipe wall. Advantageously, the deposit removal is from a plurality of small sections of pipe instead of one large section and it is easier for the fluid flow through the pipe to carry the deposit.

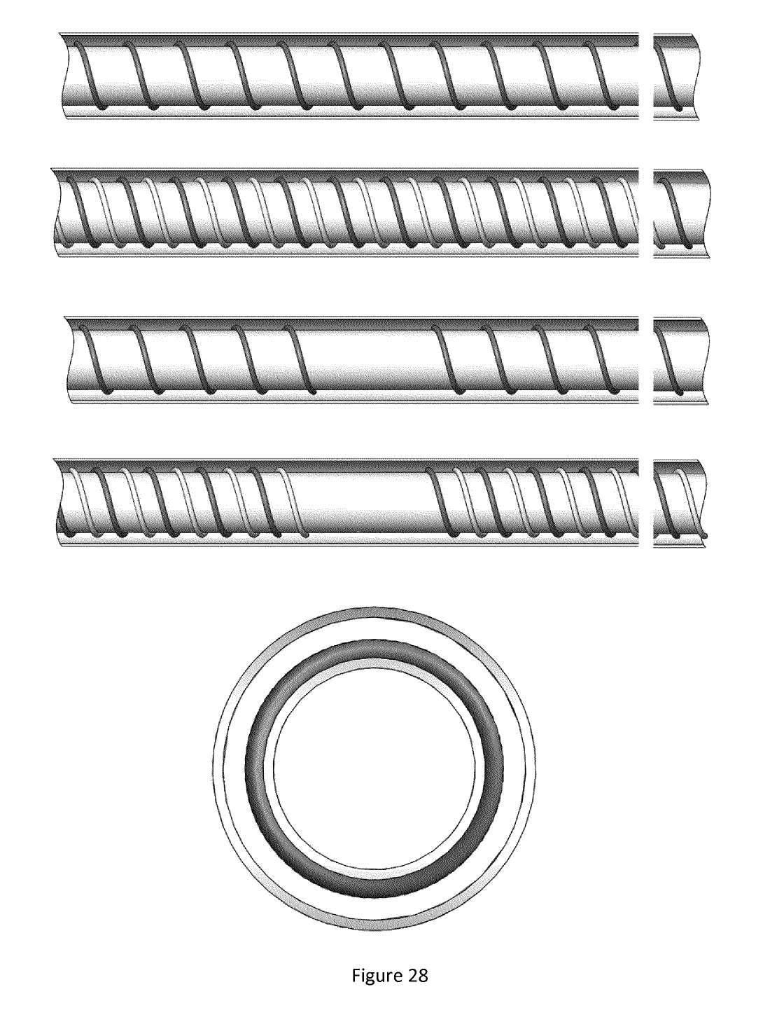

FIG. 28 shows another implementation of the present embodiment. As shown in FIG. 28, the pipe according to previous embodiments is an inner pipe and an outer pipe is provided around the inner pipe. The inner pipe is still provided with one or more heating cables as previously described. The heating cables are therefore provided in a cavity between the inner and outer pipe. The pipe-in-pipe configuration allows active cooling sections to be provided together with heating cables. Such sections can alternate between providing cooling of the flow, in order to provoke wax and hydrate formation on the inside of the pipe wall, and heating of the pipe to remove the debris. The active cooling is performed by pumping cold sea water in the cavity between the pipes, preferably as a counter-current (i.e. in the opposite direction of the production flow) so as to provide highly efficient cooling. The active cooling allows a more efficient, and smaller, cooling system to be provided. A further advantage of a pipe-in-pipe configuration is that the outer pipe serves as a protective structure for the heating cables, protecting them from external stresses or impacts. In the same way as described above, there may be a plurality of coiled sections of heating cables within the pipe-in-pipe configuration, and there may be sequential heating of the coiled heating segments.

Embodiments include a number of modifications and variations to the embodiments as described above.

The electrical power supply would typically be from a single power source on a platform on the sea surface or an onshore facility. However, embodiments include more than one power supply being used and/or the use of a subsea electrical power source.

Embodiments also include the provision and use of thermometers on the surface of the pipes and measuring the ambient temperature of the seawater, and other sensors, for providing feedback to a control system for controlling the heating of the pipes. In embodiments in which the cooling system is re-configurable, the control system preferably also controls the configuration of the cooling system and also preferable is configure to automatically control the operation of the cooling system.

Embodiments include the use of an inner pipe diameter that is less than 5.08 cm or greater than 30.48 cm and all dimensions between these limits.

Embodiments include the use of a pipe length that is less than 300 m or greater than 6000 m and all dimensions between these limits.

Although embodiments are described in the context of a subsea cooling system, embodiments include the use of the cooling system in other industries.

Embodiments have been described as periodically heating a fluid flow with the heating being performed at regular periods. Embodiments also include the heating being performed as and when required, without being restricted to being performed at regular periods. The heating is on/off, or pulse heating, with no heating for any particular part of the system being applied most of the time. The parts of the system may be heated sequentially.

The cooling systems according to embodiments may cool an input fluid to the ambient temperature of the cooling system but embodiments are not restricted to cooling to this temperature and the output fluid from the cooling system may be above ambient temperature. This reduces the cooling requirements of the cooling system and may result in little, or no, loss of performance so long as the output fluid is low enough temperature for deposit formation to be unlikely to occur. In addition, if the cooling system is provided upstream of one or more other subsea systems, such as a subsea compressor, it may be preferable for the fluid flow to be above ambient temperature.

The cooling systems of embodiments may be provided in a frame. This is particularly advantageous for subsea applications in which the cooling system needs to be lowered into place as the frame provides protection, structural stiffness and lifting points.

Preferably, the cooling systems of embodiments further comprise a cleaning system for cleaning the outside of the pipes of the cooling system. The cleaning system may clean the pipes by flushing, scraping, brushing or other techniques.

All of the implementations of the embodiment in which one or more heating cables are provided instead of inductive heating may also be applied to all of the implementations of all of the embodiments in which inductive heating is applied. For example a pipe-in-pipe configuration may be provided with active cooling and heating that is provided by inductive heating.

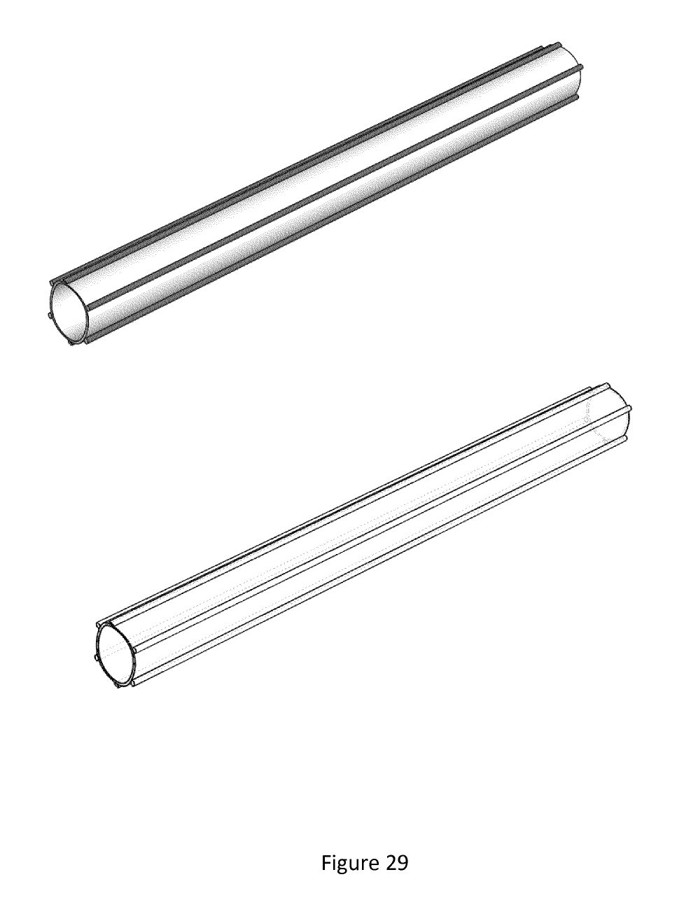

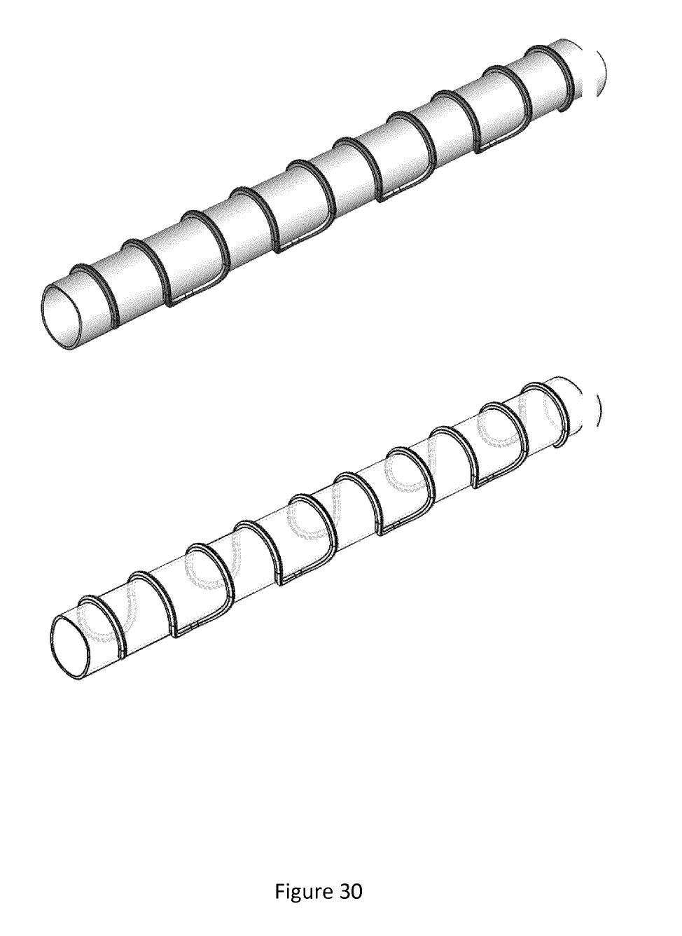

Embodiments include a plurality of independently controllable heating cables being provided with only one of the heating cables being used in a standard heating operation. The other heating cables are redundant and can be used if there is a failure of the main heating cable or if additional heating is required. As shown in FIGS. 29 and 30, the heating cables may be provided along the pipe parallel to each other in a linear, coiled or wave like configuration. The heating cables may each have the same or different dimensions. The heating cables may each have the same or different capacity rating. The heating may be generated by joule effect or simple heat transfer. Embodiments include the cable configurations as shown in FIGS. 29 and 30 being used in both a single pipe system and a pipe-in-pipe system.

Preferably, sequentially heating zones are provided along the pipe so that relatively short sections are heated one at a time. However, embodiments also include more than one, or all of the sections, being heated at the same time.

Each of the heating cables can be flat. There may also be a plurality of heating cables arranged around the circumference of a cross-section of the pipe with an equal spacing between the heating cables. Standard operation may include more than one of the heating cables being heated at the same time.

All of the heating cables referenced herein can be any known resistive heating cable, by either an AC or a DC current, or piggyback cables that apply inductive heating based on the direct electrical heating (DEH) effect.

Embodiments include a coarse subsea separator being provided upstream of the cooler(s) in order to get rid of much of the heat energy stored in the produced water. The water can then be re-injected or pumped up to the surface for treatment. By reducing the amount of warm water in the flow, the size of the cooler can be reduced and less hydrates will form. Embodiments also include providing a gas separation system for increasing the cooling effect and reducing the amount of hydrates and slugging.

Embodiments include the use of a retour pump and conduit system for pumping a cold stream from the output of the cooler to the hot end of the cooler. The retour pump and conduit system can also be used for circulating, reversing or flushing the cooler if necessary a plug or shut-down issues.

According to embodiments, there may be two operating modes of a cooling system. These are a normal production mode and a shutdown/restart mode. In the normal production mode, solids are allowed to crystalize/form. The solids that form on the pipe walls are then periodically melted off as solids, by the adhesive layer being melted and the deposits remaining in a solid state. After a shutdown of the cooling system, it is preferable to heat the system more by using the shutdown/restart mode to ensure that wax, hydrates and other deposits are in a transportable state and do not form plugs or slurry that can agglomerate or harden downstream. In the shutdown/restart mode, recycling the flow using the retour pump and conduit system is also preferable as the pump will help to mix the flow if it has separated or become lumpy.

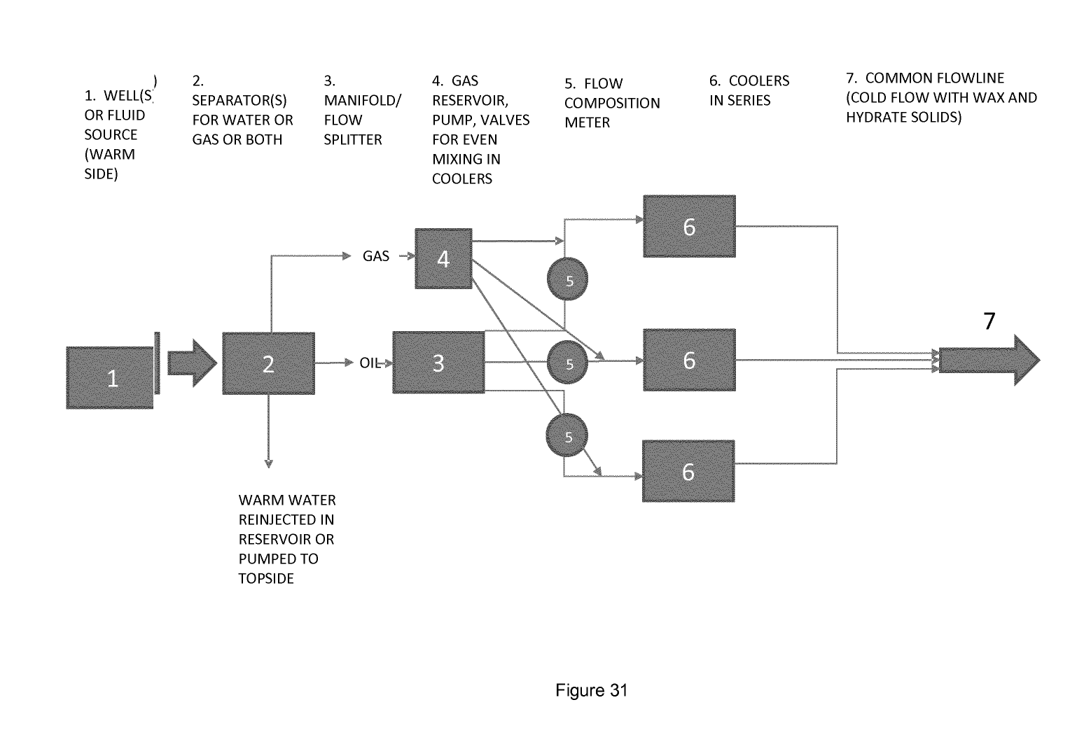

Embodiments also include the cooling systems being used in combination with subsea fluid separators as shown in FIG. 31. In FIG. 31, component 2 separates oil, water and gas from the fluid output from a wellhead. By removing the warm water some of the heat is advantageously removed. Separating the gas from the remaining liquid (which is mostly oil) is advantageous as it allows control of the fluid flowing into the cooling systems and the flow can be controlled to be homogeneous and similar in all of the cooling systems.

Successfully removing all, or most of, the water (or all the gas) from the flow, prior to splitting the flow and injecting it into several coolers, will substantially eliminate the risk of having both gas- and water constituents in the flow in some of the coolers after splitting. This may lead to hydrate formation when the flow from the different coolers are joined in a “common flowline” as shown in FIG. 31. Embodiments solve this problem by the operations shown in FIG. 31. Following steps 1 to 7 in FIG. 31, first (1) there is a mixed flow with all constituents (also water and gas) running from the fluid source. At (2) the flow in fed through a separator removing substantially all gas and water constituents prior to splitting the flow in (3). The separation at (2) may not be able to remove all of the gas and water from the flow but by substantially reducing the amount of gas and water in the flow improves the overall system performance and reduces the likelihood of downstream deposit formation occurring. To ensure a homogeneous flow composition gas is introduced to all coolers from a gas reservoir (4). The coolers in series (or parallel) will then all have the same flow composition and, importantly, they will have very little, or no, water constituents in the flow. Lastly the cold, stable state, fluid from all coolers are joined through a manifold to a common flow line If one of the cooler has water in them then a hydrate formation could potentially occur downstream in the common flow line (7). Separating the flow (as described above) substantially eliminates the risk of downstream hydrate formation.

Embodiments include applying the separation, splitting and joining techniques, as described above and shown in FIG. 31, in other applications than subsea applications. Embodiments include all operations where the separation of flow constituents is required to avoid formation mechanisms downstream as these benefit from the techniques of embodiments. In particular, embodiments may be applied in surface applications such as top-side applications.

The cooling systems can be placed in series and/or parallel but preferably a plurality of relatively small cooling systems are used in parallel with each other. The mostly oil liquid is distributed to the cooling systems by the manifold and gas is then evenly pumped in to the cooling systems.

According to embodiments, the cooling systems do not substantially heat the fluid in a pipe but only heat the pipe wall for melting the adhesive layer of the wax (or meltable deposits). The deposits themselves are now in an inert and stabile state in the bulk flow as a solid that will not agglomerate or stick to the pipe walls again.

Preferably the cooling systems of embodiments use relatively narrow diameter pipes as these have more turbulent flow than larger pipes and this increase their efficiency. The pipe diameters are therefore less than or equal to 4 inches with a plurality of cooling systems being used in series or parallel.

The power used to heat the pipe walls is whatever power is required to heat the pipe walls to an appropriate temperature for achieving the required effect. The powers may be 10 W/m, or less than 10 W/m or greater than 10 W/m.

The flowcharts and description thereof herein should not be understood to prescribe a fixed order of performing the method steps described therein. Rather the method steps may be performed in any order practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1.-71. (canceled)

72. A pipe assembly comprising:
a pipe with an electrically conductive wall with a thermally conductive outer coating;
a first electrical connector that is arranged in electrical contact with the wall of the pipe; and
a second electrical connector that is arranged in electrical contact with the wall of the pipe;
wherein the first and second electrical connectors are arranged to support the flow of an electrical current through the wall of the pipe to thereby heat the wall of the pipe; and
in use, the pipe is arranged to allow cooling of the outer surface of the wall of the pipe by the surrounding environment of the pipe when the outer surface of the wall of the pipe is hotter than its surrounding environment.

73. The pipe assembly according to claim 72, wherein an outer surface of the coating is in direct contact with the surrounding environment of the pipe and an inner surface of the coating is in direct contact with the wall of the pipe;
wherein the coating is an electrical insulator; and
wherein the coating is not designed to provide thermal insulation.

74. The pipe assembly according to claim 72, wherein the coating is a ceramic;
wherein the coating is one of boron nitride, aluminium nitride, aluminium oxide, chromium nitride, zirconium nitride, boron nitride, dichromium nitride, titanium aluminium nitride, chromium aluminium nitride, and titanium nitride, alkaline earth metal nitrides and alkali metal nitrides, and aluminium thermal spray; and
wherein no thermal insulation is provided along the length of the pipe between the first and second electrical connectors.

75. The pipe assembly according to claim 72, further comprising an electrical cable in electrical contact with the second electrical connector such that the cable is in a series electrical connection with the pipe;
wherein the cable is arranged along the length of the pipe;
wherein the cable is arranged to substantially lie along the outer surface of the pipe; and
wherein the longitudinal axes of the cable and pipe are substantially parallel with each other.

76. The pipe assembly according to claim 72, wherein the pipe assembly is for use in subsea applications.

77. The pipe assembly according to claim 72, further comprising a cooling element for cooling fluids flowing through the pipe, wherein at least part of the cooling element is located inside the pipe;
wherein:
a first end of the cooling element is located inside the pipe; and
a second end of the cooling element is located outside of the pipe;
wherein the cooling element is provided through a hole in the wall of the pipe; and
the second end of the cooling element is a heat sink.

78. A system for cooling a fluid, the system comprising:
a pipe assembly according to claim 72; and
an electrical power supply in electrical connection with the first and second connectors of the pipe assembly;
wherein the electrical power supply causes electrical current to flow through the wall of the pipe between the first and second electrical connectors in dependence on an on/off supply of the electrical current;
wherein the electrical power supply is configured to cause a direct current or an alternating current to flow through the pipe.

79. The system according to claim 78, wherein said pipe assembly comprises a plurality of said pipe assemblies.

80. The system according to claim 78, further comprising:
an input port for receiving an input fluid flow to the system;
an output port for providing an output fluid flow of fluid that has flowed through one or more pipe assemblies comprised by the system; and
a return pipe for providing a return flow path between the output port of the system and the input port of the system such that, in use, at least some of the fluid that has flowed through one or more pipe assemblies comprised by the system flows through the return pipe and through the one or more pipe assemblies again;
wherein the electrical power supply is configured to heat the return pipe in dependence on an on/off supply of electrical current.

81. The system according to claim 79, wherein the plurality of said pipe assemblies are stacked together.

82. The system according to claim 79, further comprising an electrical switching system for controlling the flow of electrical current through the pipes of each of the plurality of pipe assemblies;
wherein, for each of one or more of the pipe assemblies, the electrical switching system comprises one or more switches for controlling the flow of an electrical current through different sections of the pipe assembly.

83. The system according to claim 78, further comprising a control system for controlling the heating of the one or more pipe assemblies by the electrical power supply;
wherein the control system is configured to periodically heat one or more pipe assemblies and/or sections of each of the one or more pipe assemblies; and
wherein the system is for use in subsea applications.

84. The system according to claim 78, wherein the system is configured to receive an oil well product, that is at a higher temperature than the ambient temperature of the system, and to cool the oil well product such that the oil well product output from the system is below a deposit forming temperature of the oil well product;
wherein each pipe of the one or more pipe assemblies is arranged such that, when in use in a subsea environment, the pipe is cooled by the seawater.

85. The system according to claim 78, wherein the electrical power supply is configured to heat each pipe segment of the system once during a 24 hour period;
wherein the electrical power supply is configured to heat the wall of the pipe to at least 50° C.;
wherein, in use, the power supplied by the electrical power supply is in a range of about 1.5 kW to about 40 kW for each lm length of the wall of the segment of the pipe that is being heated; and
the power is supplied for about 120 seconds to about 660 seconds.

86. The system according to claim 78, further comprising a cleaning system for cleaning the outside of the pipes of the system.

87. A pipe assembly comprising:
a pipe; and
a heating cable arranged along the length of the pipe;
wherein, in use, the pipe is arranged to allow cooling of the outer surface of the pipe by the surrounding environment of the pipe when the outer surface of the pipe is hotter than its surrounding environment.

88. The pipe assembly according to claim 87, wherein an outer surface of the pipe, or a coating of the pipe, is in direct contact with the surrounding environment of the pipe and, if the pipe has a coating, an inner surface of the coating is in direct contact with the pipe;
wherein, if the pipe has a coating, the coating is not designed to provide thermal insulation;
wherein, if the pipe has a coating, the coating is a ceramic; and
wherein, if the pipe has a coating, the coating is one of boron nitride, aluminium nitride, aluminium oxide, chromium nitride, zirconium nitride, boron nitride, dichromium nitride, titanium aluminium nitride, chromium aluminium nitride, and titanium nitride, alkaline earth metal nitrides and alkali metal nitrides, and aluminium thermal spray.

89. The pipe assembly according to claim 87, wherein no thermal insulation is provided along the length of the pipe.

90. The pipe assembly according to claim 86, wherein the heating cable is coiled around the outer circumference of the pipe.

91. The pipe assembly according to claim 87, wherein the pipe is an inner pipe, and an outer pipe is further provided around the inner pipe;
wherein water from the outside of the outer pipe is arranged to flow through between the inside of the outer pipe and the outside of the inner pipe; and
wherein the flow of said water is in counter-current with the flow of a fluid through the inner pipe.
